(19) United States
(12) Patent Application Publication
(10) Pub. No.: US 2026/0221655 A1
(43) Pub. Date: Jul. 30, 2026

(54) RADIO FREQUENCY CHOKE-EMBEDDED DIODE TUNED PATCH ANTENNA AND ELECTRONIC APPARATUS COMPRISING SAME

(71) Applicants: Samsung Electronics Co., Ltd., Gyeonggi-do (KR); SEOUL NATIONAL UNIVERSITY R&DB FOUNDATION, Seoul (KR)

(72) Inventors: Jungi JEONG, Gyeonggi-do (KR); Jungsuek OH, Seoul (KR); Seungwoo BANG, Seoul (KR); Jaehoon KIM, Seoul (KR); Junhwa OH, Gyeonggi-do (KR)

(21) Appl. No.: 19/459,723

(22) Filed: Jan. 26, 2026

(30) Foreign Application Priority Data
Jan. 24, 2025 (KR) 10-2025-0011295

(51) Int. Cl. H01Q 9/04; H01Q 5/335

(52) U.S. Cl. CPC H01Q 9/0407; H01Q 5/335

(57) ABSTRACT

The disclosure relates to a 5^{th} generation (5G) or 6^{th} generation (6G) communication system for supporting a higher data transmission rate. A patch antenna includes a first radiator, a second radiator disposed to face the first radiator at a predetermined distance in an −X-axis direction with respect to a Y-axis, a first transmission line electrically connecting the first radiator and the second radiator, and a first radio-frequency (RF) choke electrically connected to the first radiator.

CROSS-REFERENCE TO RELATED APPLICATION(S)

This application is based on and claims priority under 35 U.S.C. §119 to Korean Patent Application No. 10-2025-0011295, filed on January 24, 2025, in the Korean Intellectual Property Office, the disclosure of which is incorporated herein by reference in its entirety.

### BACKGROUND

### 1. Field

The disclosure relates generally to an antenna, and more particularly, to a diode-controlled patch antenna with a built-in simplified radio-frequency choke, and an electronic apparatus including the same.

### 2. Description Of Related Art

5^{th} generation (5G) mobile communication technologies define broad frequency bands such that high transmission rates and new services are possible, and can be implemented not only in sub 6 gigahertz (GHz) bands such as 3.5GHz, but also in above 6GHz bands referred to as millimeter wave (mmWave) including 28GHz and 39GHz bands. In addition, it has been considered to implement 6^{th} generation (6G) mobile communication technologies (referred to as beyond 5G systems) in terahertz (THz) bands (for example, 95GHz to 3THz bands) to achieve transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide a patch antenna for reducing the number of front-end integrated circuits (ICs) and beamformer modules.

An aspect of the disclosure is to provide a patch antenna for high-frequency transmission and reception signals capable of increasing power efficiency and reducing system complexity.

An aspect of the disclosure is to provide a patch antenna capable of increasing cost efficiency and system efficiency by reducing the number of RF components.

An aspect of the disclosure is to provide a patch antenna capable of reducing the size of an antenna module regardless of miniaturization of an IC in a high-frequency environment.

An aspect of the disclosure is to provide a patch antenna capable of reducing the number of RF chokes.

In accordance with an aspect of the disclosure, a patch antenna includes a first radiator, a second radiator disposed to face the first radiator at a predetermined distance in an −X-axis direction with respect to a Y-axis, a first transmission line electrically connecting the first radiator and the second radiator, and a first radio-frequency (RF) choke electrically connected to the first radiator, wherein the first radiator comprises a first pad, a second pad disposed to be spaced apart from a first surface of the first pad by a predetermined distance in a +Z-axis direction, and a third pad disposed to be spaced apart from a first surface of the second pad by a predetermined distance in the +Z-axis direction, wherein the second radiator comprises a fourth pad, a fifth pad disposed to be spaced apart from a first surface of the fourth pad by a predetermined distance in a +Z-axis direction, and a sixth pad disposed to be spaced apart from a first surface of the fifth pad by a predetermined distance in the +Z-axis direction, wherein the first transmission line has a shape extending from one side surface of the second pad to one side surface of the fifth pad and electrically connecting the second pad and the fifth pad, and wherein an impedance (Z) value of the first transmission line is substantially infinite.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device according to an embodiment of the disclosure;

FIG. 2 illustrates a phased array antenna according to an embodiment;

FIG. 3 illustrates a patch antenna according to an embodiment;

FIG. 4 illustrates a patch antenna according to an embodiment;

FIG. 5 is a top view illustrating the patch antenna according to an embodiment;

FIG. 6 illustrates a patch antenna according to an embodiment;

FIG. 7 illustrates a patch antenna including a transmission line 1900 according to an embodiment;

FIG. 8 is a Smith chart illustrating an input impedance of a second via pad of a first radiator electrically connected to a transmission line in a patch antenna according to an embodiment;

FIG. 9 is a top view illustrating the patch antenna according to an embodiment;

FIG. 10 is a top view illustrating the patch antenna according to an embodiment;

FIG. 11 is a top view illustrating the patch antenna according to an embodiment;

FIG. 12 illustrates ground patches and diodes of a patch antenna according to an embodiment;

FIG. 13 illustrates ground patches of a patch antenna according to an embodiment;

FIG. 14 illustrates patches or pads of a radiator connected to a diode in a patch antenna according to an embodiment;

FIG. 15 illustrates transmission lines of a patch antenna according to an embodiment;

FIG. 16 illustrates transmission lines of a patch antenna according to an embodiment;

FIG. 17 illustrates RF chokes of a patch antenna according to an embodiment; and

FIG. 18 illustrates transmission lines and an RF choke of a patch antenna according to an embodiment.

### DETAILED DESCRIPTION

Hereinafter, embodiments of the disclosure will be described in detail with reference to the accompanying drawings.

Numerous variations and alternatives to the details provided herein are possible and are considered within the scope of the disclosure. In some instances, descriptions related to technical contents well-known in the art may be omitted for the sake of clarity and conciseness.

In the accompanying drawings, some elements may be exaggerated, omitted, or schematically illustrated. The size of each element does not completely reflect the actual size. Identical or corresponding elements are provided with identical reference numerals or different reference numerals.

The advantages and features of the disclosure and ways to achieve them will be apparent by making reference to embodiments as described herein in detail in conjunction with the accompanying drawings. However, the disclosure is not limited to the embodiments set forth herein, but may be implemented in various different forms. Other features, aspects, and advantages of the subject matter described herein will become apparent from the disclosure. The following embodiments are merely examples to aid in an understanding of the disclosure and should not be construed to narrow the scope or spirit of the subject matter described herein in any way, but on the contrary, the disclosure covers all modifications, equivalents and alternatives falling within the spirit and scope of the disclosure.

Throughout the specification, the same or like reference numerals designate the same or like elements. Terms which will be described herein are terms defined in consideration of the functions in the disclosure, and may be different according to users, intentions of the operators, or customs. Therefore, the definitions of the terms should be made based on the contents throughout the specification.

Hereinafter, the determination of priority between A and B may refer to various actions such as selecting the one having a higher priority based on a predefined priority rule and performing an operation corresponding thereto, or omitting or dropping an operation corresponding to the one having a lower priority.

Hereinafter, "A or B" as described in the present disclosure may be understood as "A and/or B," which may include A, or B, or both A and B.

"At least one of A, B, and C" may be understood to include A, or B, or C, or any combination of A, B, and C.

"At least one of A, B, or C" may be understood to include A, or B, or C, or any combination of A, B, and C.

"A/B" may be understood as "A and/or B," which may include A, or B, or both A and B.

"A, B" may be understood as "A and/or B," which may include A, or B, or both A and B.

"A and B" may be understood as "A and/or B," which may include A, or B, or both A and B.

Furthermore, “if condition A and condition B are satisfied,” as described herein, may not be limited to a case where both condition A and condition B are satisfied, but may be understood to include a case where either condition A or condition B is individually satisfied, both condition A and condition B are satisfied, or one or more additional conditions are satisfied in combination.

Herein, ordinal terms such as "first," "second," "third," etc., (and similar qualifiers) are used merely to distinguish between different instances, occurrences, configurations, messages, stages, elements or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a "first signal" and a "second signal" may refer to instances of the same signal transmitted at different times or containing the same core information despite minor variations, or they may refer to signals with different content or characteristics, depending on the specific context. Similarly, a "first value" and a "second value" may represent the same magnitude but measured or applied in different circumstances, or they may represent different magnitudes. The interpretation should be guided by the specific technical context, function, and relationship described in the relevant portion of the specification and claims.

The terms “first ~”, “second ~”, etc., as described herein with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Even if “first ~” and “second ~” are described in the present disclosure, it may be understood that element(s) referred to by “first ~” and “second ~” may be the same or different. For example, in case of element(s) being information, first information and second information may both be same information and, in some cases, are separate and different information.

The terms “if ~” and “in case that ~” as used herein may be interpreted to include the meanings of “when (or upon) ~,” “in response to ~,” “based on ~,” or “according to ~,” and may be used interchangeably with these expressions. Other expressions may also be used, as long as they have substantially the same meaning and do not impair the technical features of the present disclosure. If a method step (e.g. transmit a signal) is performed according to the disclosure of the application in connection with one of the above terms (such as “in case that ~” or the like), it may be interpreted to include the meanings (disclosure) of a prior determination that a feature has a specific state “~” (e.g. a bit length is above X), and then perform the method step in response to said determination.

For example, the physical layer signaling may be referred to as Layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as Layer 3 (L3) signaling. It should be noted, however, that the higher layer signaling is not limited to the aforementioned examples.

The term "not perform" as used herein may, in context, be understood to mean that the corresponding step is omitted or skipped. Such a term may be replaced with other terms having the same or substantially equivalent meaning.

"Transmitting a message including A and B" as used herein may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

"Transmitting a message including A and transmitting a message including B" may also be interpreted as transmitting a message including A and B in a single message.

Terms or components included in the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

Various modifications may be made to the methods illustrated in the flowcharts of the disclosure. For example, although illustrated as a series of steps, various steps in each drawing or flowchart may overlap, occur in parallel, occur in a different order, or be repeated. In other examples, any step may be omitted or replaced with another step.

The process of the flowchart may be performed by a device. One or more of the steps of the flowchart can be implemented by one or more processors/computer programs executing instructions to perform the noted functions.

The methods and apparatuses proposed in the embodiments of the present disclosure may be disclosed in connection with drawings disclosing flowcharts to illustrate example methods that may be implemented according to the principles of the present disclosure. Such flowcharts may contain different branches and/or sub-branches. It is understood that the principles of the present disclosure do not only contain the combination of all branches / sub-branches disclosed in the embodiment, but the present disclosure also contains at least one isolated branch / isolated sub-branch, in particular to a single branch / single sub-branch.

The methods and apparatuses disclosed herein may also be applied in combination of all or some of the embodiments in the disclosure. Therefore, the embodiments of the disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression "A" and another embodiment uses the expression "B", such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the disclosure is not limited to the terms described herein, and other terms having equivalent technical meanings may also be used. Such terms may also be interchangeable with terms defined in any 3rd generation partnership project (3GPP) technical specifications (TS) or similar technical specifications, e.g., from the European telecommunications standards institute (ETSI), where appropriate.

Hereinafter, a base station (BS) is an entity that allocates resources to terminals, and may be at least one of a gNode B, an eNode B, a Node B, a wireless access unit, a BS controller, or a node on a network.

The BS of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5G BS architectures in which such CU and DU functional splits are implemented.

A terminal may include a UE (UE), a mobile station (MS), a cellular phone, a smartphone, a computer, a tablet, a wearable device, an Internet of Things (IoT) device, or any other device/ system capable of performing communication functions.

In the disclosure, a downlink (DL) refers to a radio link through which a BS transmits a signal to a terminal, and an uplink (UL) refers to a radio link through which a terminal transmits a signal to a BS.

Hereinafter, 5G mobile communication technologies (e.g., 5G new radio (NR)), 6th generation (6G) mobile communication technologies may be described by way of example, but the embodiments herein may also be applied to other communication systems having similar technical backgrounds or channel types. For example, newly evolved mobile communication systems developed after 5G and 6G may be included. Based on determinations by those skilled in the art, the embodiments of the disclosure may also be applied to other communication systems (e.g., Wi-Fi systems) through some modifications without significantly departing from the scope of the disclosure

In the following description, the terms physical channel and signal may be used interchangeably with data or control signal. For example, the term physical DL shared channel (PDSCH) refers to a physical channel through which data is transmitted, but the term PDSCH may also be used to refer to the data itself. That is, the expression “transmit a physical channel" may be interpreted as being equivalent to the expression "transmit data or a signal via a physical channel.”

Hereinafter, higher layer signaling may refer to signaling corresponding to at least one or any combination of the following: master information block (MIB), system information block (SIB) or SIB M (M = 1, 2, ...), RRC, or MAC control element (CE), or a NAS signaling message, or an application layer message. The RRC signaling message may be referred to as L3 signaling.

L1 signaling may refer to signaling corresponding to at least one or any combination of signaling techniques using the at least one or any combination of the following physical layer channels or signaling: physical DL control channel (PDCCH), DCI, UE-specific DCI, group-common DCI, common DCI, scheduling DCI (e.g., DCI used for scheduling DL or UL data), non-scheduling DCI (e.g., DCI not used for scheduling DL or UL data) physical UL control channel (PUCCH), or UL control information (UCI). L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the present disclosure will be described in detail with reference to the accompanying drawings.

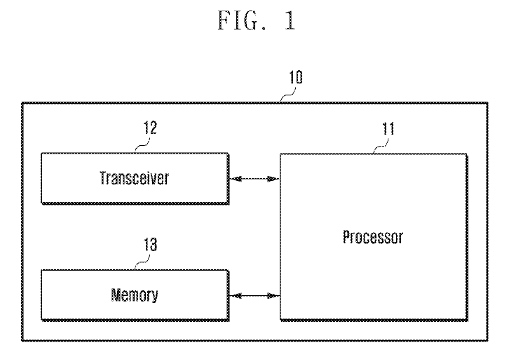

FIG. 1 is a block diagram of a BS according to an embodiment.

Referring to FIG. 1, the BS 10 may perform wireless communication with at least one UE located within the area of the BS 10 through a wireless channel. The BS 10 may perform communication with a node or an entity of a network through wired or wireless communication.

The BS 10 may include at least one transceiver (hereinafter, referred to as transceiver) 12, at least one processor (hereinafter, referred to as processor) 11, and at least one memory (hereinafter, referred to as memory) 13. According to at least one or a combination of methods corresponding to the embodiments described in the present disclosure, the transceiver 12, the processor 11, and the memory 13 of the BS 10 may operate. However, components of the BS 10 are not limited to the example components illustrated in FIG. 1. The BS 10 may further include additional components in addition to the above-mentioned components, or some components may be omitted. In some embodiments, any combination of the transceiver 12, the processor 11, or the memory 13 may be integrated in the form of one component.

The transceiver 12 may be a communication circuit or communication circuitry that enables the BS 10 to perform wireless communication with a node or an entity of a network. For example, the transceiver 12 may enable the BS 10 to transmit or receive a signal to or from a UE through cellular communication, or to transmit or receive a signal to or from another network entity through wireless communication. For example, the transceiver 12 may support various cellular communication technologies including 3rd generation (3G), 4th generation (4G), long term evolution (LTE), 5G, 6G, and various cellular wireless communication technologies supported by the transceiver 12 may include all subsequent generations of evolved wireless communications. According to an embodiment, the transceiver 12 may include various circuit structures used to transmit or receive signals to or from a UE through a wireless channel. The signals may include control information and data. For example, the transceiver 12 may include a radio frequency (RF) transmitter for up-converting and amplifying the frequency of a transmitted signal and an RF receiver for low-noise-amplifying a received signal and down-converting the frequency thereof. The transceiver 12 may output a signal received through a wireless channel to the processor 11 and may transmit, through a wireless channel, a signal output from the processor 11.

The BS 10 may perform communication with a node or an entity of a network through wired or wireless communication. For example, the BS 10 may perform wired or wireless communication with an adjacent BS, or a node or an entity of a core network through a backhaul network. Although not illustrated in FIG. 1, when the BS 10 performs wired communication, the BS 10 may further include a separate network interface for wired communication in addition to the transceiver 12. The network interface may be referred to as network interface circuitry or communication interface circuitry.

The processor 11 may control general operations of the BS 10 according to embodiments of the disclosure. The processor 12 may be implemented by one or more IC chips and may execute various data processing operations. The processor 12 may include at least one electric circuit, and may execute instructions (or a program, codes, data, etc.) stored in the memory 13, individually, collectively or in any combination thereof. The processor 11 may include a single-core processor or multi-core processor, and may include a processor assembly including a plurality of processing circuits (circuitry) according to a specific implementation scheme.

The processor 11 may be electrically, operatively, and/or communicatively coupled to the transceiver 12 to control the transceiver 12.

The processor 11 may include at least one processor (or processing circuitry), and the at least one processor may perform the following operations individually, collectively or in any combination thereof. In a specific embodiment, at least a part of the processor 12 may be included in one chip (or IC) and the other part of the processor 12 may be included in another chip (or IC). Otherwise, at least one processor may be included in another component, for example, the transceiver 12 or the memory 13.

The processor 11 may perform or control or cause an operation of the BS 10 for executing at least one or a combination of methods according to embodiments of the disclosure. For example, the processor 11 may control operations of the BS 10 for generating and transmitting a DL signal to a UE or processing an UL signal received from a UE. Otherwise, the BS 10 may transmit or receive a signal to or from a neighboring BS, transfer a signal received from a UE to an upper node of the network, or transmit a signal transferred from an upper node of the network to a UE. To this end, the processor 11 may execute a computer program, codes, or instructions stored in the memory 13, so as to control other components of the BS 10 to enable execution of various operations.

The memory 13 corresponds to a hardware storage device capable of temporarily or permanently storing information and may include one or more storage media. For example, the memory 13 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 13 may be electrically, operatively, and/or communicatively coupled to the processor 12 and may be accessed by the processor 102.

The memory 13 may store a computer program, codes, or instructions executable by the processor 11. According to an embodiment, a computer program, codes, or instructions executable by the processor 11 may be either stored in a single memory device or separated and distributedly stored in two or more memory devices. By executing the instructions stored in the memory 13, the processor 11 may perform various functions according to an embodiment.

Operations of the BS 10 may be caused to be performed based on execution of instructions (or a computer program or codes) stored in the memory 13 by at least one processor (or processing circuitry) configured to execute the same individually, collectively, or in any combination thereof, based on processing circuitry that is not configured to execute instructions, and/or based on components of processing circuitry that is not configured to execute instructions.

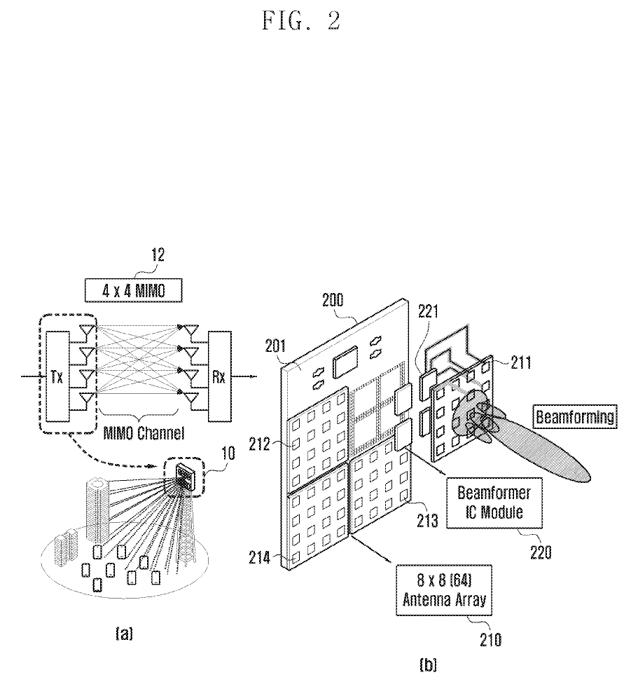

FIG. 2 illustrates a phased array antenna according to an embodiment.

Referring to FIG. 2, the phased array antenna 200 may include a substrate 201, an antenna array 210, and a beamformer IC module 220. The antenna array 210 and the beamformer IC module 220 may be disposed on the substrate 201. The substrate 201, the antenna array 210, and the beamformer IC module 220 may be electrically coupled to each other.

The antenna array 210 may be an 8×8 antenna array including 64 patch antennas. The antenna array 210 may include four 4×4 antenna arrays 211, 212, 213, and 214. Each of the 4×4 antenna arrays 211, 212, 213, and 214 may include 16 patch antennas. 64 patch antennas may be electrically coupled to each other.

The beamformer IC module 220 may include a plurality of beamformer ICs. For example, the beamformer IC module 220 may include 16 beamformer ICs. The 16 beamformer ICs may be electrically coupled to each other. 4 beamformer ICs may be electrically coupled to each of the 4×4 antenna arrays 211, 212, 213, and 214.

The beamformer IC module 220 may control a transmission signal output through the antenna array 210 based on a control signal of the processor.

The phased array antenna 200 may be referred to as a MIMO antenna having a structure in which multiple antennas are mounted in a transmitter and a receiver to obtain an improved data transmission and reception rate in a limited frequency spectrum environment.

With an inevitable shift of wireless communication frequencies toward higher frequencies, massive MIMO (mMIMO), which uses hundreds of MIMO antennas, may be evaluated as a core technology of a 6G communication system. Extreme MIMO (X-MIMO) technology capable of using thousands of MIMO antennas may be evaluated as a next-generation wireless communication technology.

In parallel with MIMO technology, beamforming technology, which forms directional beams based on multiple antennas to overcome coverage limitations of high-frequency communication, may also be considered as a next-generation technology. For example, in an antenna array 210 for beamforming based on MIMO technology, each antenna element may be fed through an RF channel of a beamformer IC module 220 including a phase shifter and a power amplifier.

The number of antenna elements for MIMO and beamforming may increase. Since a single RF channel has a one-to-one correspondence structure in which the single RF channel feeds a single antenna element, when the number of antenna elements increases, the number of beamformer IC modules 220 may also increase. The beamformer IC module 220 may be referred to as a front-end IC or a beamformer module.

In an RFIC having multiple channels, as the number of channels increases, the length of a feeding line to an antenna element becomes longer, which may reduce power efficiency and increase system complexity in a high-frequency band in which insertion loss is large.

As the number of antenna elements increases, the number of RF components, such as phase shifters in a beamforming IC module 220 and power amplifiers and low-noise amplifiers in a front-end IC, may increase exponentially, and cost efficiency of the IC and system efficiency may decrease sharply.

As a frequency band shifts toward a higher-frequency band, the size of an antenna element decreases in proportion to a wavelength; however, since miniaturization of an IC is limited, commercialization may be restricted.

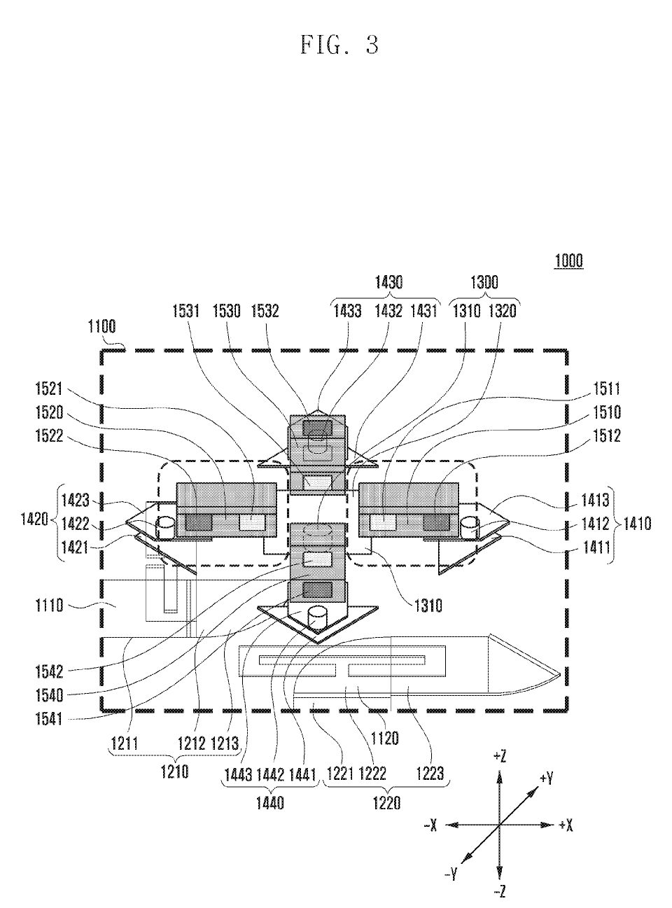

FIG. 3 illustrates a patch antenna according to an embodiment.

Referring to FIG. 3, the patch antenna 1000 may include a printed circuit board (PCB) 1100, a plurality of feeding plates 1210 and 1220, a ground portion 1300, a plurality of radiators 1410, 1420, 1430, and 1440, and a plurality of diodes 1510, 1520, 1530, and 1540.

The patch antenna 1000 may be included in the transceiver 12 of FIG. 1. The patch antenna 1000 may be substantially the same as or similar to at least one patch antenna included in the antenna array 210 of FIG. 2.

The plurality of feeding plates 1210 and 1220 may be disposed on a surface of the printed circuit board 1100.

The first feeding plate 1210 may be disposed in a first region 1110 of the surface of the PCB 1100. The first feeding plate 1210 may include a first part 1211, a second part 1212, and a third part 1213. The first part 1211 may have a shape extending by a predetermined length in a first direction (+X) from the first region 1110 of the PCB 1100. The second part 1212 may have a shape bent and extending in a second direction (+Y) from one end of the first part 1211. The second part 1212 may have a quarter-circle shape corresponding to one quarter of a circle. The third part 1213 may have a shape extending by a predetermined length in the second direction (+Y) from one end of the second part 1212. The other end of the second part 1212 may be physically coupled to the one end of the first part 1211. The one end of the second part 1212 may be physically coupled to one end of the third part 1213.

The second feeding plate 1220 may be disposed in a second region 1120 of the surface of the PCB 1100. The second feeding plate 1220 may include a first part 1221, a second part 1222, and a third part 1223. The first part 1221 may have a shape extending by a predetermined length in the second direction (+Y) from the second region 1120 of the PCB 1100. The second part 1222 may have a shape bent and extending in the first direction (+X) from one end of the first part 1221 and a quarter-circle shape corresponding to one quarter of a circle. The third part 1223 may have a shape extending by a predetermined length in the first direction (+X) from one end of the second part 1222. The other end of the second part 1222 may be physically coupled to the one end of the first part 1221 and one end of the third part 1223.

The ground portion 1300 may be disposed on the surface of the PCB 1100 and may include a ground via 1310 and a ground patch 1320. The ground via 1310 may have a shape extending by a predetermined length in a fifth direction +Z from a predetermined first point on the surface of the PCB 1100. The first point may be positioned between the second part 1212 of the first feeding plate 1210 and the second part 1222 of the second feeding plate 1220 on the PCB 1100. One end of the ground via 1310 may be electrically connected to the PCB 1100. The other end of the ground via 1310 may be electrically connected to the ground patch 1320.

The ground patch 1320 may be disposed to be spaced apart from the surface of the PCB 1100 by a predetermined distance in the fifth direction (+Z). An X–Y plane on which the ground patch 1320 is disposed may be referred to as a “third layer.” The ground patch 1320 may be disposed such that a first surface or a second surface of the ground patch 1320 is substantially parallel to the surface of the PCB 1100. The second surface of the ground patch 1320 may be electrically connected to the other end of the ground via 1310.

The plurality of radiators 1410, 1420, 1430, and 1440 may be disposed to be spaced apart from the surface of the PCB 1100 by a predetermined distance in the fifth direction (+Z). The plurality of radiators 1410, 1420, 1430, and 1440 may be disposed to be spaced apart from a first surface of each of the plurality of feeding plates 1210 and 1220 by a predetermined distance.

The first radiator 1410 may include a first patch 1411, a first via 1412, and a second patch 1413. The first patch 1411 may be disposed to be spaced apart from a predetermined second point of the PCB 1100 by a predetermined distance in the fifth direction (+Z) and may have a triangular shape having one corner oriented in the first direction (+X).

The first via 1412 may have a shape extending by a predetermined length in the fifth direction (+Z) from a point on an upper surface of the first patch 1411. One end of the first via 1412 may be electrically connected to the point on the upper surface of the first patch 1411. The other end of the first via 1412 may be electrically connected to a point on a second surface of the second patch 1413.

The second patch 1413 may be disposed to be spaced apart from the upper surface of the first patch 1411 by a predetermined distance in the fifth direction (+Z). The second patch 1413 may be disposed such that the first surface or the second surface of the second patch 1413 is substantially parallel to the upper surface of the first patch 1411. A point on the second surface of the second patch 1413 may be electrically connected to the other end of the first via 1412. The second patch 1413 may have a pentagonal shape having one corner oriented in the first direction (+X).

The second radiator 1420 may include a first patch 1421, a first via 1422, and a second patch 1423. The first patch 1421 may be disposed to be spaced apart from a predetermined third point on the PCB 1100 or a predetermined first point on the first feeding plate 1210 by a predetermined distance in the fifth direction (+Z). The first patch 1421 may have a triangular shape having one corner oriented in the second direction −X.

The first via 1422 may have a shape extending by a predetermined length in the fifth direction (+Z) from a point on an upper surface of the first patch 1421. One end of the first via 1422 may be electrically connected to the point on the upper surface of the first patch 1421. The other end of the first via 1422 may be electrically connected to a point on a second surface of the second patch 1423.

The second patch 1423 may be disposed to be spaced apart from the upper surface of the first patch 1421 by a predetermined distance in the fifth direction (+Z). The second patch 1423 may be disposed such that the first surface or the second surface of the second patch 1423 is substantially parallel to the upper surface of the first patch 1421. A point on the second surface of the second patch 1423 may be electrically connected to the other end of the first via 1422. The second patch 1423 may have a pentagonal shape having one corner oriented in the second direction (−X).

The third radiator 1430 may include a first patch 1431, a first via 1432, and a second patch 1433. The first patch 1431 may be disposed to be spaced apart from a predetermined fourth point of the PCB 1100 by a predetermined distance in the fifth direction (+Z). The first patch 1431 may have a triangular shape having one corner oriented in the third direction (+Y).

The first via 1432 may have a shape extending by a predetermined length in the fifth direction (+Z) from a point on an upper surface of the first patch 1431. One end of the first via 1432 may be electrically connected to the point on the upper surface of the first patch 1431. The other end of the first via 1432 may be electrically connected to a point on a second surface of the second patch 1433.

The second patch 1433 may be disposed to be spaced apart from the upper surface of the first patch 1431 by a predetermined distance in the fifth direction (+Z). The second patch 1433 may be disposed such that the first surface or the second surface of the second patch 1433 is substantially parallel to the upper surface of the first patch 1431. A point on the second surface of the second patch 1433 may be electrically connected to the other end of the first via 1432. The second patch 1433 may have a pentagonal shape having one corner oriented in the first direction (+X).

The fourth radiator 1440 may include a first patch 1441, a first via 1442, and a second patch 1443. The first patch 1441 may be disposed to be spaced apart from a predetermined fifth point on the PCB 1100 or a predetermined first point on the first feeding plate 1220 by a predetermined distance in the fifth direction (+Z). The first patch 1441 may have a triangular shape having one corner oriented in the fourth direction −Y.

The first via 1442 may have a shape extending by a predetermined length in the fifth direction (+Z) from a point on an upper surface of the first patch 1441. One end of the first via 1442 may be electrically connected to the point on the upper surface of the first patch 1441. The other end of the first via 1442 may be electrically connected to a point on a second surface of the second patch 1443.

The second patch 1443 may be disposed to be spaced apart from the upper surface of the first patch 1441 by a predetermined distance in the fifth direction (+Z). The second patch 1443 may be disposed such that a first surface or a second surface of the second patch 1443 is substantially parallel to the upper surface of the first patch 1441. A point on the second surface of the second patch 1443 may be electrically connected to the other end of the first via 1442. The second patch 1443 may have a pentagonal shape having one corner oriented in the second direction (−X).

The plurality of diodes 1510, 1520, 1530, and 1540 may be disposed on upper surfaces of the plurality of radiators 1410, 1420, 1430, and 1440, respectively. Each of the plurality of diodes 1510, 1520, 1530, and 1540 may have a hexagonal shape having a predetermined size; however, the shape is not limited thereto, and various shapes may be employed. Each of the plurality of diodes 1510, 1520, 1530, and 1540 may be a varactor diode or a PIN diode; however, the diode is not limited thereto, and various types of diodes may be used.

The first diode 1510 may have a hexahedral shape extending from a region on a first surface of the ground portion 1300 to a region on a first surface of the first radiator 1410; however, the shape is not limited thereto. The first diode 1510 may be electrically connected to the ground portion 1300 and the first radiator 1410. The first diode 1510 may include a first electrode 1511 and a second electrode 1512. The first electrode 1511 may be electrically connected to the ground portion 1300 and to a first surface of the ground patch 1310. The second electrode 1512 may be electrically connected to a first surface of the second patch 1413 of the first radiator 1410.

The first electrode 1511 may be a cathode. The second electrode 1512 may be an anode. The ground patch 1310 electrically connected to the first electrode 1511 may be a cathode. Depending on a difference between direct current (DC) voltages applied to the first electrode 1511 and the second electrode 1512, the first diode 1510 may exhibit various electrical characteristics. The first diode 1510 may be controlled through the difference in the DC voltage.

The second diode 1520 may have a hexahedral shape extending from a region on the first surface of the ground portion 1300 to a region on a surface of the second radiator 1420; however, the shape is not limited thereto. The second diode 1520 may be electrically connected to the ground portion 1300 and the second radiator 1420. The second diode 1520 may include a first electrode 1521 and a second electrode 1522. The first electrode 1521 may be electrically connected to the ground portion 1300 and to the first surface of the ground patch 1310. The second electrode 1522 may be electrically connected to a first surface of the second patch 1423 of the second radiator 1420.

The first electrode 1521 may be a cathode. The second electrode 1522 may be an anode. The ground patch 1310 electrically connected to the first electrode 1521 may be a cathode. Depending on a difference between DC voltages applied to the first electrode 1521 and the second electrode 1522, the second diode 1520 may exhibit various electrical characteristics. The second diode 1520 may be controlled through the difference in the DC voltage.

The third diode 1530 may have a hexahedral shape extending from a region on the first surface of the ground portion 1300 to a region on the first surface of the third radiator 1430; however, the shape is not limited thereto. The third diode 1530 may be electrically connected to the ground portion 1300 and the third radiator 1430. The third diode 1530 may include a first electrode 1531 and a second electrode 1532. The first electrode 1531 may be electrically connected to the ground portion 1300 and to the first surface of the ground patch 1310. The second electrode 1532 may be electrically connected to a first surface of the second patch 1433 of the third radiator 1430.

The first electrode 1531 may be a cathode. The second electrode 1532 may be an anode. The ground patch 1310 electrically connected to the first electrode 1531 may be a cathode. Depending on a difference between DC voltages applied to the first electrode 1531 and the second electrode 1532, the third diode 1530 may exhibit various electrical characteristics. The third diode 1530 may be controlled through the difference in the DC voltage.

The fourth diode 1540 may have a hexahedral shape extending from a region on a first surface of the ground portion 1300 to a region on a surface of the fourth radiator 1440; however, the shape is not limited thereto. The fourth diode 1540 may be electrically connected to the ground portion 1300 and the fourth radiator 1440. The fourth diode 1540 may include a first electrode 1541 and a second electrode 1542. The first electrode 1541 may be electrically connected to the ground portion 1300 and to the first surface of the ground patch 1310. The second electrode 1542 may be electrically connected to the first surface of the second patch 1443 of the fourth radiator 1440.

The first electrode 1541 may be a cathode. The second electrode 1542 may be an anode. The ground patch 1310 electrically connected to the first electrode 1541 may be a cathode. Depending on a difference between DC voltages applied to the first electrode 1541 and the second electrode 1542, the fourth diode 1540 may exhibit various electrical characteristics. The fourth diode 1540 may be controlled through the difference in the DC voltage.

The surface of the PCB 1100 on which the ground portion 1300 is disposed may be referred to as a first layer. An X–Y plane on which first patches 1411, 1421, 1431, and 1441 of respective ones of the plurality of radiators 1410, 1420, 1430, and 1440 are disposed may be referred to as a second layer. The X–Y plane on which second patches 1413, 1423, 1433, and 1443 of respective ones of the plurality of radiators 1410, 1420, 1430, and 1440 are disposed may be referred to as a third layer.

The patch antenna 1000 may be a dual-polarized antenna that provides co-polarization (co-pol) and cross-polarization (cross-pol). The second diode 1520 may be disposed to face the first diode 1510 in the second direction (−X) with respect to the ground portion 1300 on the X–Y plane. The first diode 1510 and the second diode 1520 may operate as a diode pair that provides co-polarization (co-pol) or cross-polarization (cross-pol). The fourth diode 1540 may be disposed to face the third diode 1530 in the fourth direction −Y with respect to the ground portion 1300 on the X–Y plane. The third diode 1530 and the fourth diode 1540 may operate as a diode pair that provides co-polarization or cross-polarization.

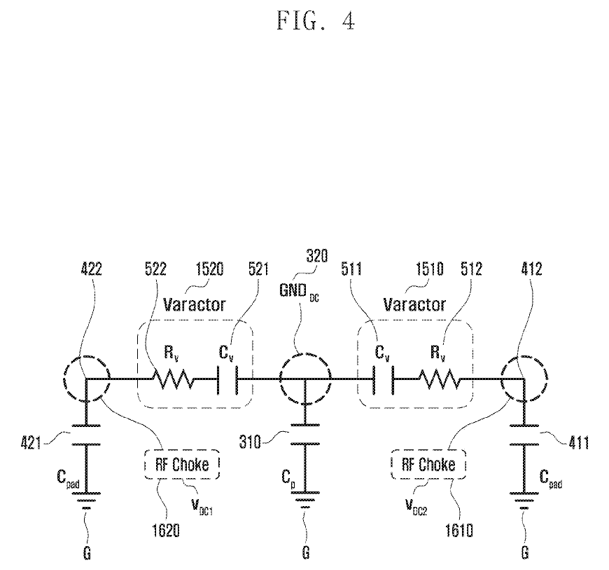

FIG. 4 illustrates a patch antenna according to an embodiment.

Referring to FIG. 4, the patch antenna may include a ground capacitor (C_{P}) 310, a ground node (GND_{DC}) 320, a first diode capacitor (C_{pad}) 511, a second diode capacitor (C_{pad}) 521, a first resistor (R_{V}) 512, a second resistor (R_{V}) 522, a first radiation capacitor (C_{V}) 411, a second radiation capacitor (C_{V}) 421, and a plurality of RF chokes 1610 and 1620.

The ground capacitor 310 may correspond to the ground via 1310. The ground capacitor 310 may be included in the ground via 1310. The ground node 320 may correspond to the ground patch 1320. The ground node 320 may be included in the ground patch 1320.

The first diode capacitor 511 and the first diode resistor 512 may be included in the first diode 1510. The second diode capacitor 521 and the second diode resistor 522 may be included in the second diode 1520.

The first radiation capacitor 412 may correspond to the first via 1412 of the first radiator 1410. The first radiation capacitor 412 may be included in the first via 1412 of the first radiator 1410. The second radiation capacitor 422 may correspond to the first via 1422 of the second radiator 1420. The second radiation capacitor 422 may be included in the first via 1422 of the second radiator 1420.

The ground node 320 may be electrically connected to one end of the ground capacitor 310, one end of the first diode capacitor 511, and one end of the second diode capacitor 521. The other end of the ground capacitor 310 may be grounded (G).

The one end of the first diode capacitor 511 may be electrically connected to the ground node 320. The other end of the first diode capacitor 511 may be electrically connected to one end of the first diode resistor 512. The one end of the first diode resistor 512 may be electrically connected to the other end of the first diode capacitor 511. The other end of the first diode resistor 512 may be electrically connected to one end of the first RF choke 1610 and one end of the first radiation capacitor 411. The other end of the first RF choke 1610 may be electrically connected to a first voltage V_{DC1}1710. The one end of the first radiation capacitor 411 may be electrically connected to the other end of the first diode resistor 512. The other end of the first radiation capacitor 411 may be grounded (G).

The one end of the second diode capacitor 521 may be electrically connected to the ground node 320. The other end of the second diode capacitor 521 may be electrically connected to one end of the second diode resistor 522. The one end of the second diode resistor 522 may be electrically connected to the other end of the second diode capacitor 521. The other end of the second diode resistor 522 may be electrically connected to one end of the second RF choke 1620 and one end of the second radiation capacitor 421. The other end of the second RF choke 1620 may be electrically connected to a second voltage V_{DC2}1720. The one end of the second radiation capacitor 421 may be electrically connected to the other end of the second diode resistor 522. The other end of the second radiation capacitor 421 may be grounded (G).

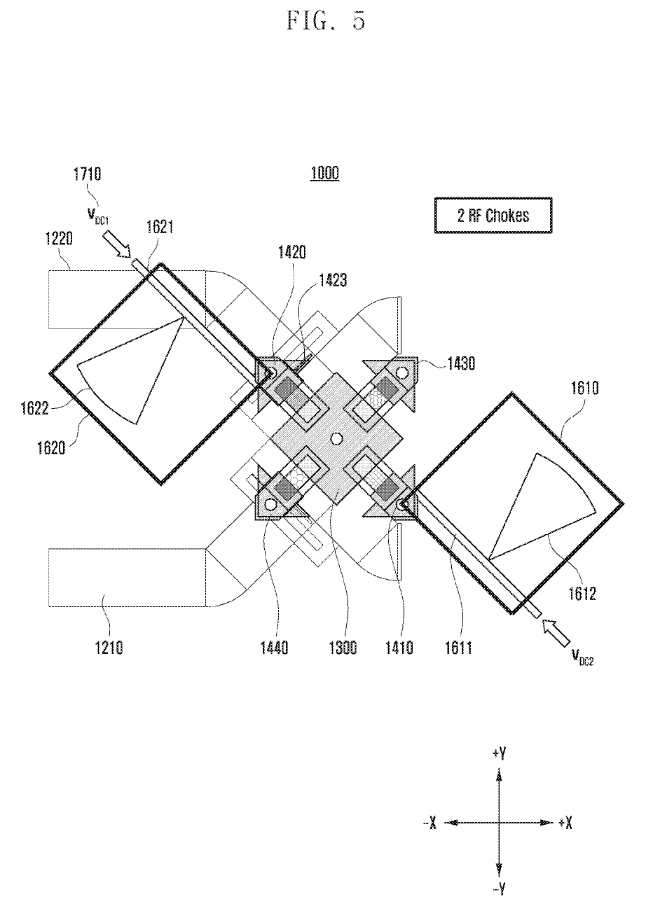

The first RF choke 1610 and the second RF choke 1620 may be disposed as illustrated in FIG. 5.

FIG. 5 is a top view illustrating a patch antenna according to an embodiment.

Referring to FIG. 5, the patch antenna 1000 may include a plurality of RF chokes 1610 and 1620.

The first RF choke 1610 may include a first feeding line 1611 and a first radial stub 1612. A first end of the first feeding line 1611 may be electrically connected to the second patch 1413 of the first radiator 1410. A second end of the first feeding line 1611 may be electrically connected to the first radial stub 1612. A third end of the first feeding line 1611 may be electrically connected to a first voltage V_{DC1}1710. The first feeding line 1611 may have an electrical length of λ/4. The first radial stub 1612 may have a fan shape that extends and expands in the third direction (+Y) with respect to the second end of the first feeding line 1611.

The second RF choke 1620 may include a second feeding line 1621 and a second radial stub 1622. A first end of the second feeding line 1621 may be electrically connected to the second patch 1423 of the second radiator 1420. A second end of the second feeding line 1621 may be electrically connected to the second radial stub 1622. A third end of the second feeding line 1621 may be electrically connected to a second voltage V_{DC2}1720. The second feeding line 1621 may have an electrical length of λ/4. The second radial stub 1622 may have a fan shape that extends and expands in a fourth direction −Y with respect to the second end of the second feeding line 1621.

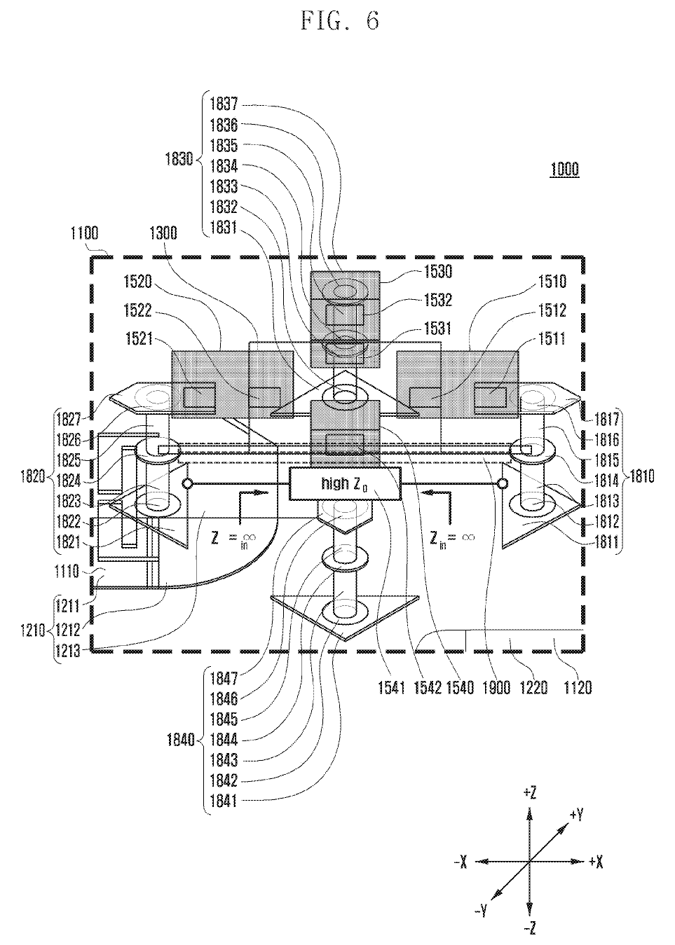

FIG. 6 illustrates a patch antenna according to an embodiment.

Referring to FIG. 6, the patch antenna 1000 may include a PCB 1100, a plurality of feeding plates 1210 and 1220, a ground portion 1300, a plurality of radiators 1810, 1820, 1830, and 1840, a plurality of diodes 1510, 1520, 1530, and 1540, and a transmission line 1900.

The patch antenna 1000 may be included in the transceiver 12 of FIG. 1. The patch antenna 1000 may be substantially the same as or similar to at least one patch antenna included in the antenna array 210 of FIG. 2.

The plurality of feeding plates 1210 and 1220 may be disposed on a surface of the PCB 1100.

The first feeding plate 1210 may be disposed in a first region 1110 of the surface of the PCB 1100. The first feeding plate 1210 may include a first part 1211, a second part 1212, and a third part 1213. The first part 1211 may have a shape extending by a predetermined length in a first direction (+X) from the first region 1110 of the PCB 1100. The second part 1212 may have a shape bent and extending in a second direction (+Y) from one end of the first part 1211. The second part 1212 may have a quarter-circle shape corresponding to one quarter of a circle. The third part 1213 may have a shape extending by a predetermined length in the second direction (+Y) from one end of the second part 1212, which may be physically coupled to one end of the third part 1213 while the other end of the second part 1212 may be physically coupled to the one end of the first part 1211.

The second feeding plate 1220 may be disposed in a second region 1120 of the surface of the PCB 1100. The second feeding plate 1220 may include a first part 1221, a second part 1222, and a third part 1223. The first part 1221 may have a shape extending by a predetermined length in the second direction (+Y) from the second region 1120 of the PCB 1100. The second part 1222 may have a shape bent and extending in the first direction (+X) from one end of the first part 1221. The second part 1222 may have a quarter-circle shape corresponding to one quarter of a circle. The third part 1223 may have a shape extending by a predetermined length in the first direction (+X) from one end of the second part 1222, which may be physically coupled to one end of the third part 1223 while the other end of the second part 1222 may be physically coupled to the one end of the first part 1221.

The ground portion 1300 may include a ground patch 1320. The ground patch 1320 may be disposed to be spaced apart from the surface of the PCB 1100 by a predetermined distance in the fifth direction (+Z). An X–Y plane on which the ground patch 1320 is disposed may be referred to as a “third layer.” The ground patch 1320 may be disposed such that a first surface or a second surface of the ground patch 1320 is substantially parallel to the surface of the PCB 1100.

The plurality of radiators 1810, 1820, 1830, and 1840 may be disposed on the surface of the PCB 1100.

The first radiator 1810 may include a first patch 1811, a first via pad 1812, a first via 1813, a second via pad 1814, a second via 1815, a third via pad 1816, and a second patch 1817.

The first patch 1811 may be disposed at a predetermined second point on the surface of the PCB 1100. The first patch 1811 may have a triangular shape having one corner oriented in the first direction (+X).

The first via pad 1812 may be disposed on a first surface of the first patch 1811 or may be embedded in the first surface of the first patch 1811.

The first via 1813 may have a shape extending by a predetermined distance in the fifth direction (+Z) from a point on a first surface of the first via pad 1812. One end of the first via 1813 may be electrically connected to the point on the first surface of the first via pad 1812. The other end of the first via 1813 may be electrically connected to a point on a second surface of the second via pad 1814.

The second via pad 1814 may be disposed to be spaced apart from an upper surface of the first patch 1811 by a predetermined distance in the fifth direction (+Z). The second via pad 1814 may be electrically connected to the first via 1813 and the second via 1815. The second surface of the second via pad 1814 may be electrically connected to the other end of the first via 1813. A first surface of the second via pad 1814 may be electrically connected to one end of the second via 1815.

The second via 1815 may have a shape extending by a predetermined distance in the fifth direction (+Z) from a point on the first surface of the second via pad 1814. The one end of the second via 1815 may be electrically connected to the point on the first surface of the first via pad 1814. The other end of the first via 1815 may be electrically connected to a point on a second surface of the third via pad 1816.

The third via pad 1816 may be disposed to be spaced apart from an upper surface of the second via pad 1814 by a predetermined distance in the fifth direction (+Z). The third via pad 1816 may be electrically connected to the second via 1815 and the second patch 1817. The second surface of the third via pad 1816 may be electrically connected to the other end of the first via 1815. The first surface of the second via pad 1814 may be electrically connected to a second surface of the second patch 1817.

The second patch 1817 may be disposed to be spaced apart from the upper surface of the first patch 1811 by a predetermined distance in the fifth direction (+Z). The second patch 1817 may be disposed such that a first surface or a second surface of the second patch 1817 is substantially parallel to the upper surface of the first patch 1811. A point on the second surface of the second patch 1817 may be electrically connected to the other end of the third via pad 1816. The second patch 1817 may have a pentagonal shape having one corner oriented in the first direction (+X).

The second radiator 1820 may include a first patch 1821, a first via pad 1822, a first via 1823, a second via pad 1824, a second via 1825, a third via pad 1826, and a second patch 1827.

The first patch 1821 may be disposed at a predetermined third point on the surface of the PCB 1100. The first patch 1821 may have a triangular shape having one corner oriented in the second direction (−X).

The first via pad 1822 may be disposed on a first surface of the first patch 1821 or may be embedded in the first surface of the first patch 1821.

The first via 1823 may have a shape extending by a predetermined distance in the fifth direction (+Z) from a point on a first surface of the first via pad 1822. One end of the first via 1823 may be electrically connected to the point on the first surface of the first via pad 1822. The other end of the first via 1823 may be electrically connected to a point on a second surface of the second via pad 1824.

The second via pad 1824 may be disposed to be spaced apart from the upper surface of the first patch 1821 by a predetermined distance in the fifth direction (+Z). The second via pad 1824 may be electrically connected to the first via 1823 and the second via 1825. The second surface of the second via pad 1824 may be electrically connected to the other end of the first via 1823. A first surface of the second via pad 1824 may be electrically connected to one end of the second via 1825.

The second via 1825 may have a shape extending by a predetermined distance in the fifth direction (+Z) from a point on the first surface of the second via pad 1824. The one end of the second via 1825 may be electrically connected to the point on the first surface of the first via pad 1824. The other end of the first via 1825 may be electrically connected to a point on a second surface of the third via pad 1826.

The third via pad 1826 may be disposed to be spaced apart from the upper surface of the second via pad 1824 by a predetermined distance in the fifth direction (+Z). The third via pad 1826 may be electrically connected to the second via 1825 and the second patch 1827. The second surface of the third via pad 1826 may be electrically connected to the other end of the first via 1825. A first surface of the third via pad 1826 may be electrically connected to a second surface of the second patch 1827.

The second patch 1827 may be disposed to be spaced apart from the upper surface of the first patch 1821 by a predetermined distance in the fifth direction (+Z). The second patch 1827 may be disposed such that a first surface or a second surface of the second patch 1827 is substantially parallel to the upper surface of the first patch 1821. A point on the second surface of the second patch 1827 may be electrically connected to the other end of the third via pad 1826. The second patch 1827 may have a pentagonal shape having one corner oriented in the second direction (−X).

The third radiator 1830 may include a first patch 1831, a first via pad 1832, a first via 1833, a second via pad 1834, a second via 1835, a third via pad 1836, and a second patch 1837.

The first patch 1831 may be disposed at a predetermined fourth point on the surface of the PCB 1100. The first patch 1831 may have a triangular shape having one corner oriented in the third direction (+Y).

The first via pad 1832 may be disposed on a first surface of the first patch 1831 or may be embedded in the first surface of the first patch 1831.

The first via 1833 may have a shape extending by a predetermined distance in the fifth direction (+Z) from a point on a first surface of the first via pad 1832. One end of the first via 1833 may be electrically connected to the point on the first surface of the first via pad 1832. The other end of the first via 1833 may be electrically connected to a point on a second surface of the second via pad 1834.

The second via pad 1834 may be disposed to be spaced apart from the upper surface of the first patch 1831 by a predetermined distance in the fifth direction (+Z). The second via pad 1834 may be electrically connected to the first via 1833 and the second via 1835. The second surface of the second via pad 1834 may be electrically connected to the other end of the first via 1833. A first surface of the second via pad 1834 may be electrically connected to one end of the second via 1835.

The second via 1835 may have a shape extending by a predetermined distance in the fifth direction (+Z) from a point on the first surface of the second via pad 1834. The one end of the second via 1835 may be electrically connected to the point on the first surface of the second via pad 1834. The other end of the second via 1835 may be electrically connected to a point on a second surface of the third via pad 1836.

The third via pad 1836 may be disposed to be spaced apart from an upper surface of the second via pad 1834 by a predetermined distance in the fifth direction (+Z). The third via pad 1836 may be electrically connected to the second via 1835 and the second patch 1837. The second surface of the third via pad 1836 may be electrically connected to the other end of the second via 1835. A first surface of the third via pad 1836 may be electrically connected to a second surface of the second patch 1837.

The second patch 1837 may be disposed to be spaced apart from the upper surface of the first patch 1831 by a predetermined distance in the fifth direction (+Z). The second patch 1837 may be disposed such that a first surface or a second surface of the second patch 1837 is substantially parallel to the upper surface of the first patch 1831. A point on the second surface of the second patch 1837 may be electrically connected to the other end of the third via pad 1836. The second patch 1837 may have a pentagonal shape having one corner oriented in the third direction (+Y).

The fourth radiator 1840 may include a first patch 1841, a first via pad 1842, a first via 1843, a second via pad 1844, a second via 1845, a third via pad 1846, and a second patch 1847.

The first patch 1841 may be disposed at a predetermined fifth point on the surface of the PCB 1100. The first patch 1843 may have a triangular shape having one corner oriented in the fourth direction (−Y).

The first via pad 1842 may be disposed on a first surface of the first patch 1841 or may be embedded in the first surface of the first patch 1841.

The first via 1843 may have a shape extending by a predetermined distance in the fifth direction (+Z) from a point on a first surface of the first via pad 1842. One end of the first via 1843 may be electrically connected to the point on the first surface of the first via pad 1842. The other end of the first via 1843 may be electrically connected to a point on a second surface of the second via pad 1844.

The second via pad 1844 may be disposed to be spaced apart from the upper surface of the first patch 1841 by a predetermined distance in the fifth direction (+Z). The second via pad 1844 may be electrically connected to the first via 1843 and the second via 1845. The second surface of the second via pad 1844 may be electrically connected to the other end of the first via 1843. A first surface of the second via pad 1844 may be electrically connected to one end of the second via 1845.

The second via 1845 may have a shape extending by a predetermined distance in the fifth direction (+Z) from a point on the first surface of the second via pad 1844. The one end of the second via 1845 may be electrically connected to the point on the first surface of the second via pad 1844. The other end of the first via 1845 may be electrically connected to a point on a second surface of the third via pad 1846.

The third via pad 1846 may be disposed to be spaced apart from the upper surface of the second via pad 1844 by a predetermined distance in the fifth direction (+Z). The third via pad 1846 may be electrically connected to the second via 1845 and the second patch 1847. The second surface of the third via pad 1846 may be electrically connected to the other end of the first via 1843. The first surface of the second via pad 1844 may be electrically connected to a second surface of the second patch 1847.

The second patch 1847 may be disposed to be spaced apart from the upper surface of the first patch 1841 by a predetermined distance in the fifth direction (+Z). The second patch 1847 may be disposed such that a surface or a second surface of the second patch 1847 is substantially parallel to the upper surface of the first patch 1841. A point on the second surface of the second patch 1847 may be electrically connected to the other end of the third via pad 1846. The second patch 1847 may have a pentagonal shape having one corner oriented in the fourth direction (−Y).

The plurality of diodes 1510, 1520, 1530, and 1540 may be disposed on upper surfaces of the plurality of radiators 1410, 1420, 1430, and 1440, respectively. Each of the plurality of diodes 1510, 1520, 1530, and 1540 may have a hexagonal shape having a predetermined size; however, the shape is not limited thereto, and various shapes may be employed. Each of the plurality of diodes 1510, 1520, 1530, and 1540 may be a varactor diode or a PIN diode; however, the diode is not limited thereto, and various types of diodes may be used.

The first diode 1510 may have a hexahedral shape extending from a region on the first surface of the ground portion 1300 to a region on a first surface of the first radiator 1810; however, the shape is not limited thereto. The first diode 1510 may be electrically connected to the ground portion 1300 and the first radiator 1810. The first diode 1510 may include a first electrode 1511 and a second electrode 1512. The first electrode 1511 may be electrically connected to the ground portion 1300 and to a first surface of the ground patch 1310. The second electrode 1512 may be electrically connected to a first surface of the second patch 1817 of the first radiator 1810.

The first electrode 1511 may be a cathode. The second electrode 1512 may be an anode. The ground patch 1310 electrically connected to the first electrode 1511 may be a cathode. Depending on a difference between DC voltages applied to the first electrode 1511 and the second electrode 1512, the first diode 1510 may exhibit various electrical characteristics. The first diode 1510 may be controlled through the difference in the DC voltage.

The second diode 1520 may have a hexahedral shape extending from a region on the first surface of the ground portion 1300 to a region on the first surface of the second radiator 1820; however, the shape is not limited thereto. The second diode 1520 may be electrically connected to the ground portion 1300 and the second radiator 1820. The second diode 1520 may include a first electrode 1521 and a second electrode 1522. The first electrode 1521 may be electrically connected to the ground portion 1300 and to the first surface of the ground patch 1310. The second electrode 1522 may be electrically connected to a first surface of the second patch 1827 of the second radiator 1820.

The first electrode 1521 may be a cathode. The second electrode 1522 may be an anode. The ground patch 1310 electrically connected to the first electrode 1521 may be a cathode. Depending on a difference between DC voltages applied to the first electrode 1521 and the second electrode 1522, the second diode 1520 may exhibit various electrical characteristics. The second diode 1520 may be controlled through the difference in the DC voltage.

The third diode 1530 may have a hexahedral shape extending from a region on the first surface of the ground portion 1300 to a region on a first surface of the third radiator 1830; however, the shape is not limited thereto. The third diode 1530 may be electrically connected to the ground portion 1300 and the third radiator 1830. The third diode 1530 may include a first electrode 1531 and a second electrode 1532. The first electrode 1531 may be electrically connected to the ground portion 1300 and to the first surface of the ground patch 1310. The second electrode 1532 may be electrically connected to a first surface of the second patch 1837 of the third radiator 1830.

The first electrode 1531 may be a cathode. The second electrode 1532 may be an anode. The ground patch 1310 electrically connected to the first electrode 1531 may be a cathode. Depending on a difference between DC voltages applied to the first electrode 1531 and the second electrode 1532, the third diode 1530 may exhibit various electrical characteristics. The third diode 1530 may be controlled through the difference in the DC voltage.

The fourth diode 1540 may have a hexahedral shape extending from a region on the first surface of the ground portion 1300 to a region on a first surface of the fourth radiator 1840; however, the shape is not limited thereto. The fourth diode 1540 may be electrically connected to the ground portion 1300 and the fourth radiator 1840. The fourth diode 1540 may include a first electrode 1541 and a second electrode 1542. The first electrode 1541 may be electrically connected to the ground portion 1300 and to the first surface of the ground patch 1310. The second electrode 1542 may be electrically connected to a first surface of the second patch 1847 of the fourth radiator 1840.

The first electrode 1541 may be a cathode. The second electrode 1542 may be an anode. The ground patch 1310 electrically connected to the first electrode 1541 may be a cathode. Depending on a difference between DC voltages applied to the first electrode 1541 and the second electrode 1542, the fourth diode 1540 may exhibit various electrical characteristics. The fourth diode 1540 may be controlled through the difference in the DC voltage.

The surface of the PCB 1100 on which at least one of the ground plates 1110 and 1120, first patches 1811, 1821, 1831, and 1841 or first via pads 1812, 1822, 1832, and 1842 of respective ones of the plurality of radiators 1810, 1820, 1830, and 1840, is disposed may be referred to as a first layer. An X–Y plane on which second via pads 1814, 1824, 1834, and 1844 of respective ones of the plurality of radiators 1810, 1820, 1830, and 1840 are disposed may be referred to as a second layer. An X–Y plane on which third via pads 1816, 1826, 1836, and 1846 or second patches 1817, 1827, 1837, and 1847 of respective ones of the plurality of radiators 1810, 1820, 1830, and 1840 are disposed may be referred to as a third layer.

The transmission line 1900 may be disposed to be spaced apart from the surface of the PCB 1100 by a predetermined distance in a fifth direction (+Z). The transmission line 1900 may be electrically connected to at least two of the second via pads 1814, 1824, 1834, and 1844 of respective ones of the plurality of radiators 1810, 1820, 1830, and 1840. For example, the transmission line 1900 may be electrically connected to the second via pad 1814 of the first radiator 1810 and the second via pad 1824 of the second radiator 1820. The transmission line 1900 may have a shape extending from the second via pad 1814 of the first radiator 1810 to the second via pad 1824 of the second radiator 1820. One end of the transmission line 1900 may be electrically connected to the second via pad 1814 of the first radiator 1810. The other end of the transmission line 1900 may be electrically connected to the second via pad 1824 of the second radiator 1820. The transmission line 1900 may have a high impedance (high Z₀).

The patch antenna 1000 may be a dual-polarized antenna that provides co-polarization (co-pol) and cross-polarization (cross-pol). The second diode 1520 may be disposed to face the first diode 1510 in the second direction (−X) with respect to the ground portion 1300 on the X–Y plane. The first diode 1510 and the second diode 1520 may operate as a diode pair that provides co-polarization (co-pol) or cross-polarization (cross-pol). The fourth diode 1540 may be disposed to face the third diode 1530 in the fourth direction −Y with respect to the ground portion 1300 on the X–Y plane. The third diode 1530 and the fourth diode 1540 may operate as a diode pair that provides co-polarization or cross-polarization.

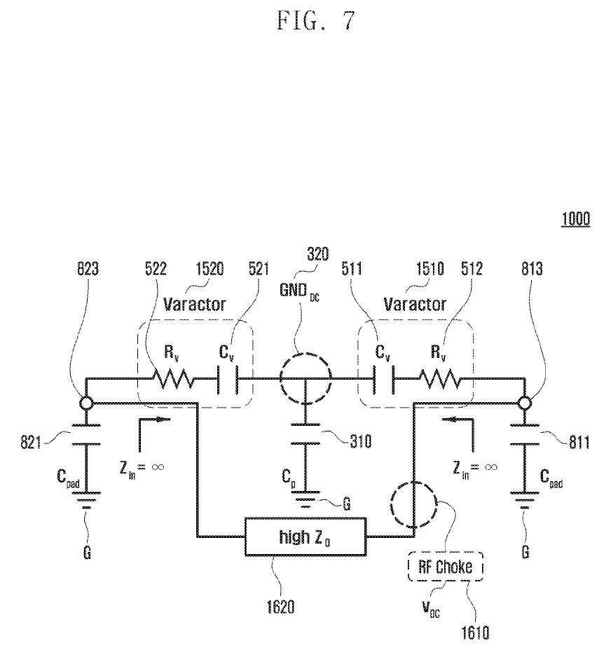

FIG. 7 illustrates a patch antenna including a transmission line 1900 according to an embodiment.

Referring to FIG. 7, the patch antenna 1000 may include a ground capacitor (C_{P}) 310, a ground node (GND_{DC}) 320, a first diode capacitor (Cᵥ) 511, a second diode capacitor (Cᵥ) 521, a first resistor (R_{V}) 512, a second resistor (R_{V}) 522, a first radiation capacitor (C_{pad}) 811, a second radiation capacitor (C_{pad}) 821, and a first RF choke 1610.

The ground capacitor 310 may correspond to the ground via 1310 and may be included in the ground via 1310. The ground node 320 may correspond to the ground patch 1320 and may be included in the ground patch 1320.

The first diode capacitor 511 and the first diode resistor 512 may be included in the first diode 1510. The second diode capacitor 521 and the second diode resistor 522 may be included in the second diode 1520.

The first radiation capacitor 812 may correspond to and be included in the first via 1813 of the first radiator 1810.

The second radiation capacitor 822 may correspond to and be included in the first via 1823 of the second radiator.

The ground node 320 may be electrically connected to one end of the ground capacitor 310, one end of the first diode capacitor 511, and one end of the second diode capacitor 521. The other end of the ground capacitor 310 may be grounded (G).

The one end of the first diode capacitor 511 may be electrically connected to the ground node 320. The other end of the first diode capacitor 511 may be electrically connected to one end of the first diode resistor 512. The one end of the first diode resistor 512 may be electrically connected to the other end of the first diode capacitor 511. The other end of the first diode resistor 512 may be electrically connected to a first radiation node 814. The first radiation node 814 may correspond to the second via pad 1814 of the first radiator 1810. The first radiation node 814 may be electrically connected to the other end of the first diode resistor 512 and to the other end of the first radiation capacitor 811. The one end of the first radiation capacitor 811 may be electrically connected to the other end of the first diode resistor 512. The other end of the first radiation capacitor 811 may be grounded (G).

The one end of the second diode capacitor 521 may be electrically connected to the ground node 320. The other end of the second diode capacitor 521 may be electrically connected to one end of the second diode resistor 522. The one end of the second diode resistor 522 may be electrically connected to the other end of the second diode capacitor 521. The other end of the second diode resistor 522 may be electrically connected to a second radiation node 824. The second radiation node 824 may correspond to the second via pad 1824 of the second radiator 1820. The second radiation node 824 may be electrically connected to the other end of the second diode resistor 522 and the other end of the second radiation capacitor 821. The one end of the second radiation capacitor 821 may be electrically connected to the other end of the second diode resistor 522. The other end of the second radiation capacitor 821 may be grounded (G).

One end of the transmission line 900 may be electrically connected to the first radiation node 814. The other end of the transmission line 900 may be electrically connected to the second radiation node 824. The transmission line 900 may have a high impedance (high Z₀).

One end of the first RF choke 1610 may be electrically connected to the transmission line 900. The other end of the first RF choke 1610 may be electrically connected to a first voltage V_{DC1}1710.

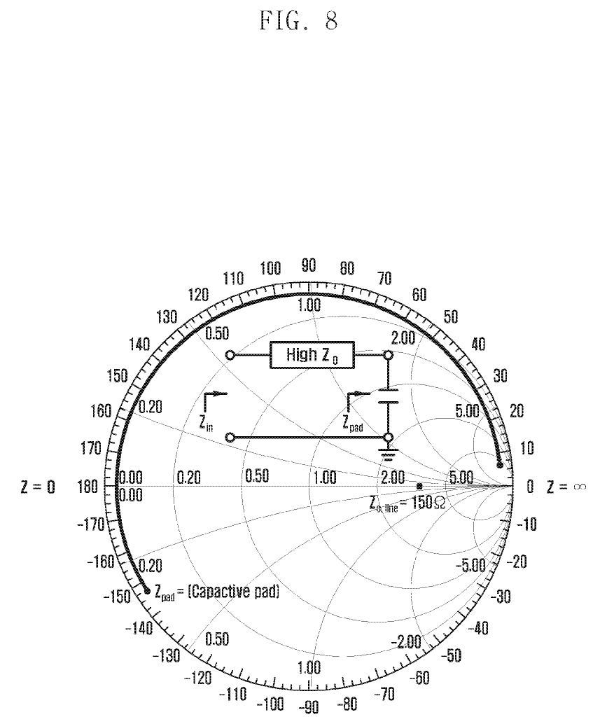

FIG. 8 is a Smith chart illustrating an input impedance of a second via pad of a first radiator electrically connected to a transmission line in a patch antenna according to an embodiment.

Referring to FIG. 8, a Smith chart related to an input impedance of the second via pad of the first radiator of the patch antenna including the transmission line 900 having a high impedance (high Z₀) is shown.

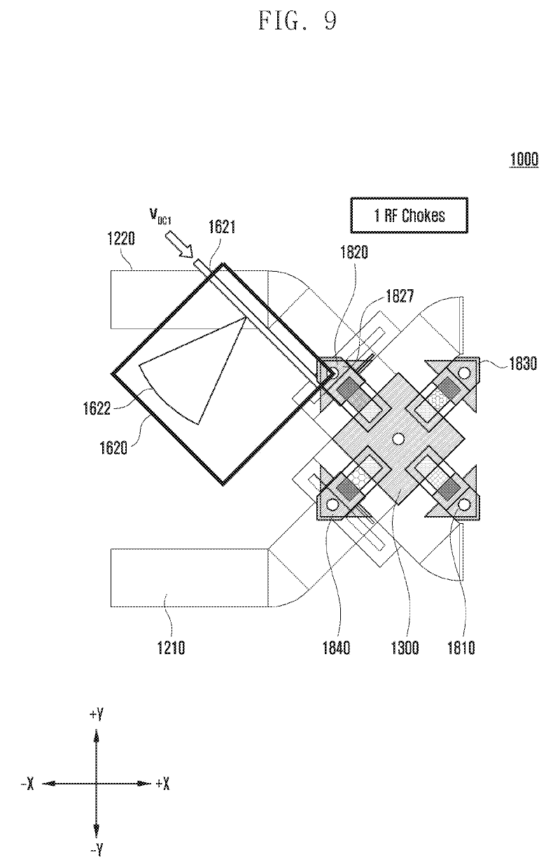

FIG. 9 is a top view illustrating the patch antenna according to an embodiment.

Referring to FIG. 9, the patch antenna 1000 may include a first RF choke 1620.

The first RF choke 1620 may include a first feeding line 1621 and a first radial stub 1622. A first end of the first feeding line 1621 may be electrically connected to a first radiator 1820 and to a second patch 1827 of the second radiator 1820. A second end of the first feeding line 1621 may be electrically connected to the first radial stub 1622. A third end of the first feeding line 1621 may be electrically connected to a first voltage V_{DC1}1910. The first feeding line 1621 may have an electrical length of λ/4. The first radial stub 1622 may have a fan shape that extends and expands in a fourth direction (−Y) with respect to the second end of the first feeding line 1621.

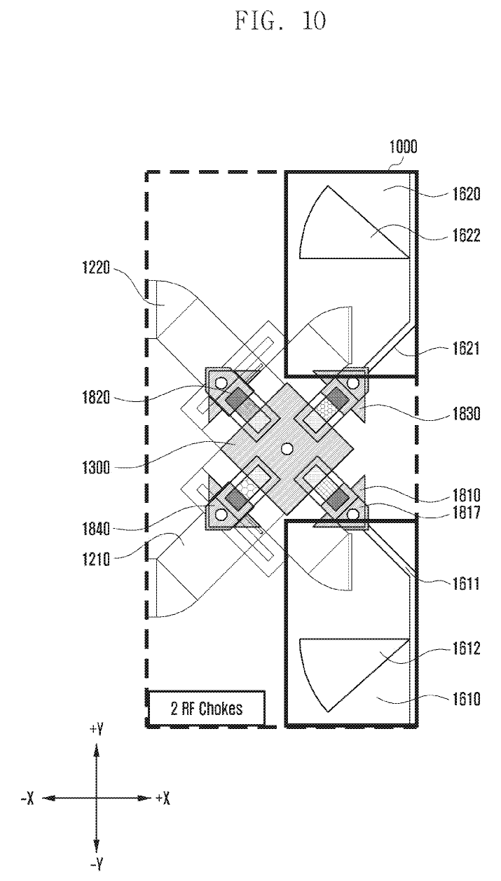

FIG. 10 is a top view illustrating the patch antenna according to an embodiment.

Referring to FIG. 10, the patch antenna 1000 may include a first RF choke 1610 and a second RF choke 1620.

The first RF choke 1610 may include a first feeding line 1611 and a first radial stub 1612. A first end of the first feeding line 1611 may be electrically connected to the first radiator 1810 and to the second patch 1817 of the first radiator 1810. A second end of the first feeding line 1611 may be electrically connected to the first radial stub 1612. A third end of the first feeding line 1611 may be electrically connected to a first voltage V_{DC1}. The first feeding line 1611 may have an electrical length of λ/4. The first radial stub 1612 may have a fan shape that extends and expands in a second direction (−X) with respect to the second end of the first feeding line 1611.

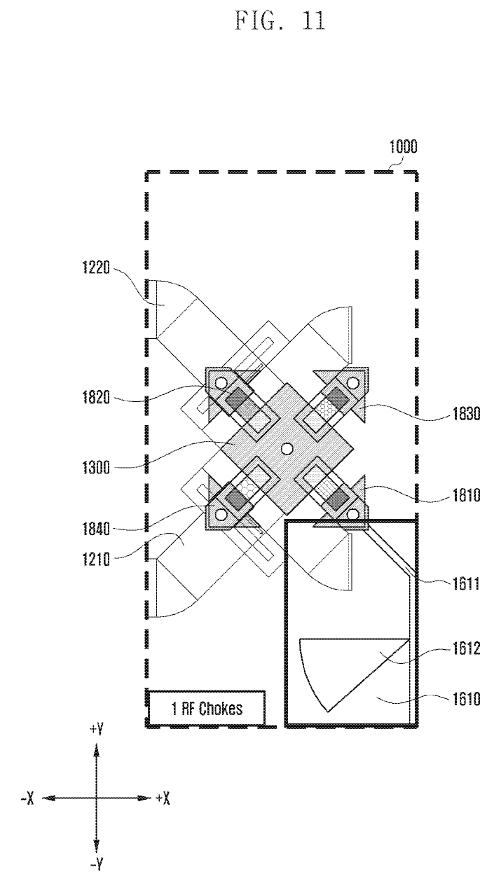

FIG. 11 is a top view illustrating the patch antenna according to an embodiment.

Referring to FIG. 11, the patch antenna 1000 may include a first RF choke 1610. The patch antenna 1000 may have a structure in which the second RF choke 1620 is omitted, as compared with the patch antenna 1000 of FIG. 10. Otherwise, the first RF choke 1610 may be substantially the same as or similar to the first RF choke 1610 of FIG. 10.

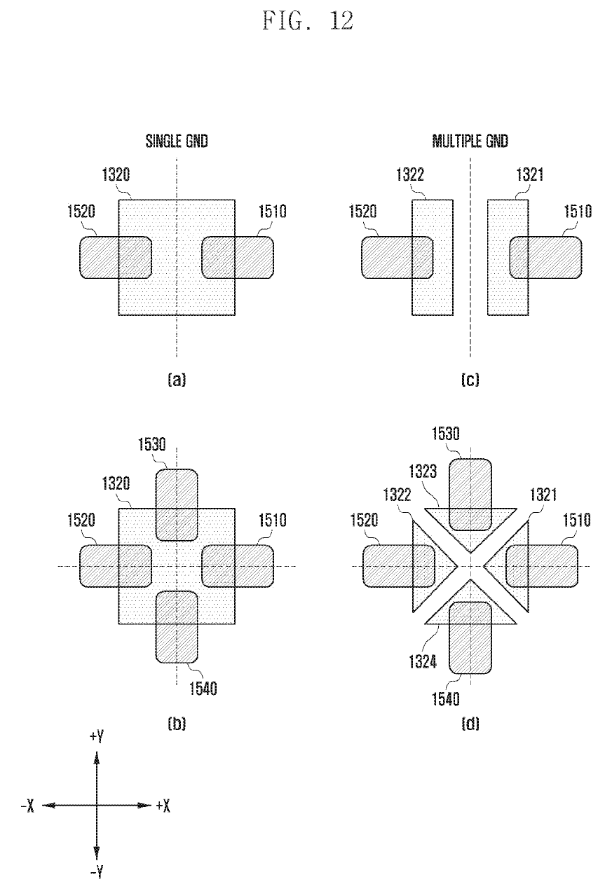

FIG. 12 is a top view illustrating a ground patch and diodes of a patch antenna according to an embodiment.

Referring to section (a) of FIG. 12, the patch antenna may include a ground patch 1320, a first diode 1510, and a second diode 1520. The ground patch 1320 may be referred to as a single ground patch. The ground patch 1320 may have a square shape with respect to an X–Y plane. The first diode 1510 may be electrically connected to a first point of the ground patch 1320. The second diode 1520 may be disposed to face the first diode 1510 in a second direction (−X) with respect to the Y-axis and may be electrically connected to a second point on the ground patch 1320.

Referring to section (b) of FIG. 12, the patch antenna may include one ground patch 1320, a first diode 1510, a second diode 1520, a third diode 1530, and a fourth diode 1540. The ground patch 1320 may have a square shape with reference to an X–Y plane. The first diode 1510 may be electrically connected to a first point on the ground patch 1320. The second diode 1520 may be disposed to face the first diode 1510 in the second direction (−X) with respect to the Y-axis and may be electrically connected to a second point on the ground patch 1320. The third diode 1530 may be electrically connected to a third point on the ground patch 1320. The fourth diode 1540 may be disposed to face the third diode 1530 in a fourth direction (−Y) with respect to an X-axis and may be electrically connected to a fourth point on the ground patch 1320.

Referring to section (c) of FIG. 12, the patch antenna may include a ground patch 1320, a first diode 1510, and a second diode 1520. The ground patch 1320 may be referred to as a multiple ground patch. The ground patch 1320 may include a first ground patch 1321 and a second ground patch 1322 which may be physically spaced apart from each other. The first ground patch 1321 and the second ground patch 1322 may each have a rectangular shape extending in a third direction (+Y) and the fourth direction (−Y), respectively, with respect to an X–Y plane. The first diode 1510 may be electrically connected to a point of the first ground patch 1321. The second diode 1520 may be disposed to face the first diode 1510 in the second direction (−X) with respect to the Y-axis and may be electrically connected to a point on the second ground patch 1322.

Referring to section (d) of FIG. 12, the patch antenna may include a ground patch 1320, a first diode 1510, a second diode 1520, a third diode 1530, and a fourth diode 1540. The ground patch 1320 may be referred to as a multiple ground patch and may include a first ground patch 1321, a second ground patch 1322, a third ground patch 1323, and a fourth ground patch 1324 which may be physically spaced apart from each other. The first ground patch 1321, the second ground patch 1322, the third ground patch 1323, and the fourth ground patch 1324 may each have a right triangular shape having a corner oriented toward an origin (0,0) with reference to an X–Y plane. The first diode 1510 may be electrically connected to a point on the first ground patch 1321. The second diode 1520 may be disposed to face the first diode 1510 in the second direction (−X) with respect to a Y-axis and may be electrically connected to a point on the second ground patch 1322. The third diode 1530 may be electrically connected to a point on the third ground patch 1323. The fourth diode 1540 may be disposed to face the third diode 1530 in the fourth direction (−Y) with respect to an X-axis and may be electrically connected to a point on the fourth ground patch 1324.

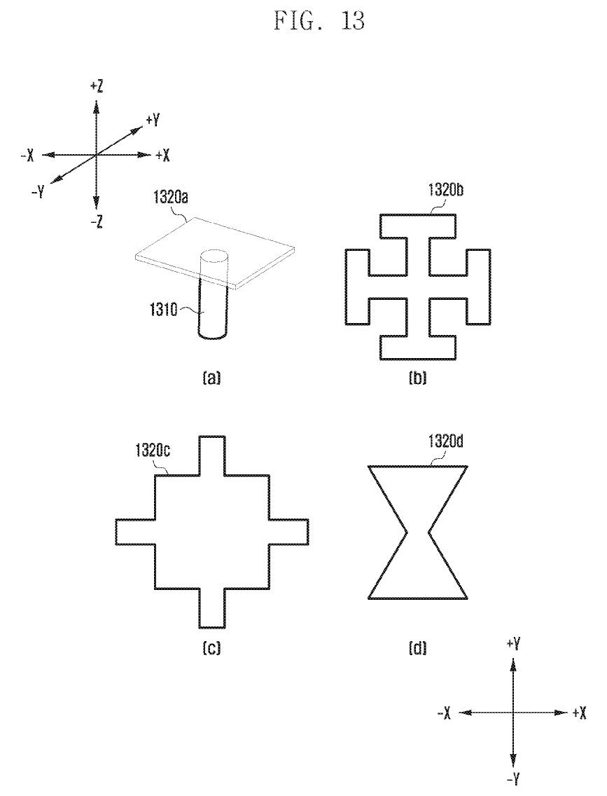

FIG. 13 illustrates ground patches of a patch antenna according to an embodiment.

Referring to section (a) of FIG. 13, the ground patch 1320a may have a square shape with reference to an X–Y plane. A point on a second surface of the ground patch 1320a may be electrically connected to a ground via 1310. One end of the ground via 1310 may be electrically connected to the second surface of the ground patch 1320a. The other end of the ground via 1310 may be grounded .

Referring to section (b) of FIG. 13, a ground patch 1320b may have a quad-T cross shape with reference to the X–Y plane.

Referring to section (c) of FIG. 13, a ground patch 1320c may have a stepped shape with reference to the X–Y plane.

Referring to section (d) of FIG. 13, the ground patch 1320d may have a bow-tie shape with reference to the X–Y plane.

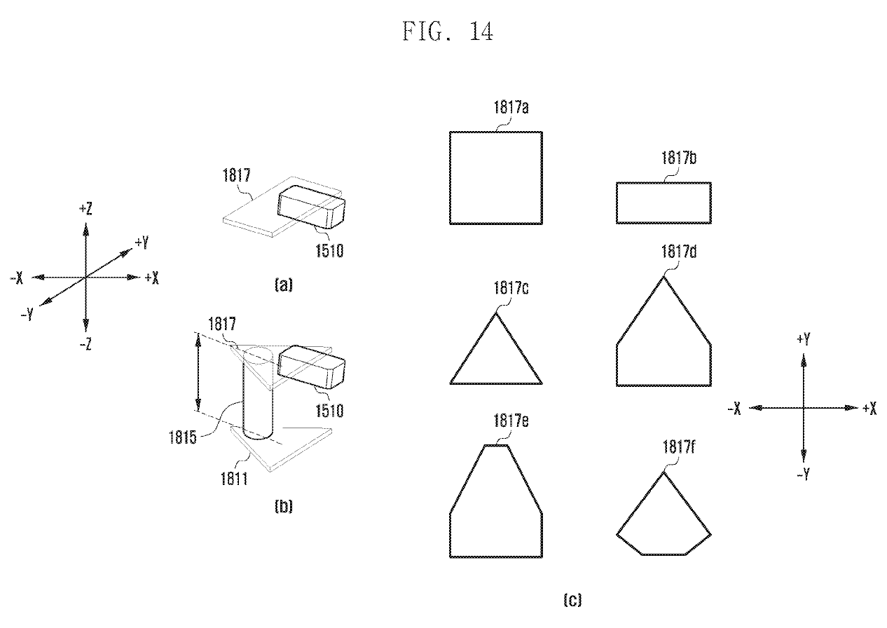

FIG. 14 illustrates patches or pads of a radiator electrically connected to a diode in a patch antenna according to an embodiment.

Referring to section (a) of FIG. 14, a second patch 1817 may be electrically connected to a second diode 1510 and may have a square shape with reference to an X–Y plane.

Referring to section (b) of FIG. 14, the second patch 1817 may be electrically connected to the second diode 1520. A first patch 1811 may be electrically connected to the second patch 1817 through at least one of a first via 1813 and a second via 1815. The first patch 1811 and the second patch 1817 may have equilateral triangular shapes, each having one corner oriented in a second direction (−X).

Referring to section (c) of FIG. 14, a second patch 1817a may have a square shape with reference to the X–Y plane. A second patch 1817b may have a rectangular shape extending in a first direction(+X) and the second direction (−X) with reference to an X–Y plane. A second patch 1817c may have an equilateral triangular shape with reference to the X–Y plane. A second patch 1817d may have a pentagonal shape protruding in a third direction (+Y) with reference to the X–Y plane. A second patch 1817e may have a hexagonal shape protruding in the third direction (+Y) with reference to an X–Y plane. A second patch 1817f may have a pentagonal shape protruding in the first direction (+X), the second direction (−X), and the third direction (+Y) with reference to the X–Y plane.

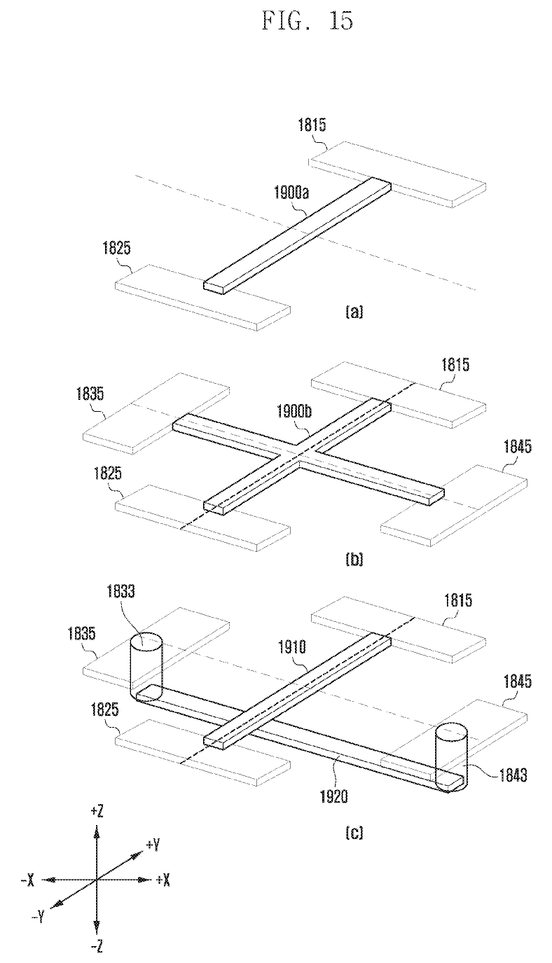

FIG. 15 illustrates transmission lines of a patch antenna according to an embodiment.

Referring to section (a) of FIG. 15, a transmission line 1900a may be electrically connected to a second pad 1815 of a first radiator 1810 and a second pad 1825 of a second radiator 1820. One end of the transmission line 1900a may be electrically connected to one side surface of the second pad 1815 of the first radiator 1810. The other end of the transmission line 1900a may be electrically connected to one side surface of the second pad 1825 of the second radiator 1820. The transmission line 1900a may have a bar shape extending from one side surface of the second pad 1815 of the first radiator 1810 to one side surface of the second pad 1825 of the second radiator 1820.

Referring to section (b) of FIG. 15, a transmission line 1900b may be electrically connected to a second pad 1815 of a first radiator 1810, a second pad 1825 of a second radiator 1820, a second pad 1835 of a third radiator 1830, and a second pad 1845 of a fourth radiator 1840. A first end of the transmission line 1900b may be electrically connected to one side surface of the second pad 1815 of the first radiator 1810. A second end of the transmission line 1900b may be electrically connected to one side surface of the second pad 1825 of the second radiator 1820. A third end of the transmission line 1900b may be electrically connected to one side surface of the second pad 1835 of the third radiator 1830. A fourth end of the transmission line 1900b may be electrically connected to one side surface of the second pad 1845 of the fourth radiator 1840. The transmission line 1900b may have a cross-shaped configuration extending, from a center of the transmission line 1900b, such that the first end extends in a first direction (+X), the second end extends in a second direction (−X), the third end extends in a third direction (+Y), and the fourth end extends in a fourth direction (−Y).

Referring to section (c) of FIG. 15, the transmission line 1900 may include a first transmission line 1910 and a second transmission line 1920. The first transmission line 1910 may be electrically connected to a second pad 1815 of the first radiator 1810 and a second pad 1825 of the second radiator 1820. One end of the first transmission line 1910 may be electrically connected to one side surface of the second pad 1815 of the first radiator 1810. The other end of the first transmission line 1910 may be electrically connected to one side surface of the second pad 1825 of the second radiator 1820. The first transmission line 1910 may have a bar shape extending from one side surface of the second pad 1815 of the first radiator 1810 to one side surface of the second pad 1825 of the second radiator 1820.

The second transmission line 1920 may be electrically connected to the other end of a second via 1833 of the third radiator 1830 and the other end of a second via 1843 of the fourth radiator 1840. One end of the second via 1833 of the third radiator 1830 may be electrically connected to a second surface of the second pad 1835 of the third radiator 1830. A first end of the second via 1843 of the fourth radiator 1840 may be electrically connected to a second surface of the second pad 1845 of the fourth radiator 1840. Alternatively, the second transmission line 1910 may be electrically connected to the other end of a first via 1833 of the third radiator 1830 and the other end of a first via 1843 of the fourth radiator 1840. The one end of the first via 1833 of the third radiator 1830 may be electrically connected to the second surface of the second pad 1835 of the third radiator 1830. One end of the first via 1843 of the fourth radiator 1840 may be electrically connected to the second surface of the second pad 1845 of the fourth radiator 1840. The second transmission line 1920 may have a bar shape extending from one side surface of the second pad 1835 of the third radiator 1830 to one side surface of the second pad 1845 of the fourth radiator 1840.

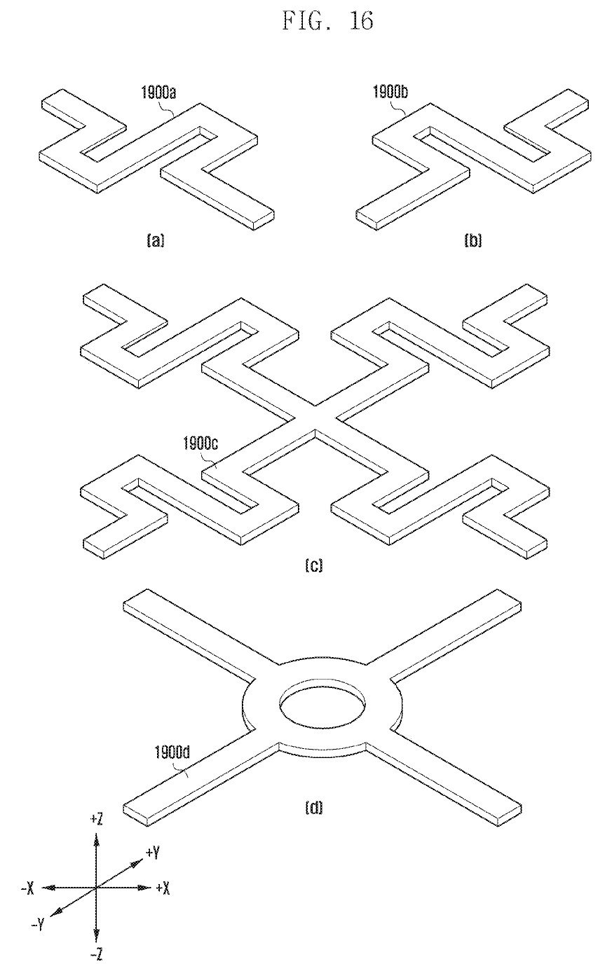

FIG. 16 illustrates transmission lines of a patch antenna according to an embodiment.

Referring to section (a) of FIG. 16, a transmission line 1900a may have a shape that meanders (or zig-zags) while extending in a second direction (−X) from one end of the transmission line 1900a. The transmission line 1900a may extend in a meandering shape so as to have a length capable of providing an optimal impedance value. One end of the transmission line 1900a may be electrically connected to a second pad of a first radiator. The other end of the transmission line 1900a may be electrically connected to a second pad of a second radiator.

Referring to section (b) of FIG. 16, a transmission line 1900b may have a shape that meanders while extending in a fourth direction (−Y) from one end of the transmission line 1900b. The transmission line 1900b may extend in a meandering shape so as to have a length capable of providing an optimal impedance value. One end of the transmission line 1900b may be electrically connected to a second pad of a third radiator. The other end of the transmission line 1900b may be electrically connected to a second pad of a fourth radiator.

Referring to section (c) of FIG. 16, a transmission line 1900c may have a cross shape in which, from the center of the transmission line 1900c, a first end extends in a first direction (+X), a second end extends in a second direction (−X), a third end extends in a third direction (+Y), and a fourth end extends in a fourth direction (−Y), each in a meandering manner. The first end of the transmission line 1900c may be electrically connected to one side surface of a second pad of a first radiator. The second end of the transmission line 1900c may be electrically connected to one side surface of a second pad of a second radiator. The third end of the transmission line 1900c may be electrically connected to one side surface of a second pad of a third radiator. The fourth end of the transmission line 1900c may be electrically connected to one side surface of a second pad of a fourth radiator.

Referring to section (d) of FIG. 16, a transmission line 1900d may have a cross shape including a loop at the center thereof. The transmission line 1900d may have a cross shape in which a first end extends in a first direction (+X) from a first point of the central loop, a second end extends in a second direction (−X) from a second point of the central loop, a third end extends in a third direction (+Y) from a third point of the central loop, and a fourth end extends in a fourth direction (−Y) from a fourth point of the central loop. The first end of the transmission line 1900d may be electrically connected to one side surface of a second pad of a first radiator. The second end of the transmission line 1900d may be electrically connected to one side surface of a second pad of a second radiator. The third end of the transmission line 1900d may be electrically connected to one side surface of a second pad of a third radiator. The fourth end of the transmission line 1900d may be electrically connected to one side surface of a second pad of a fourth radiator.

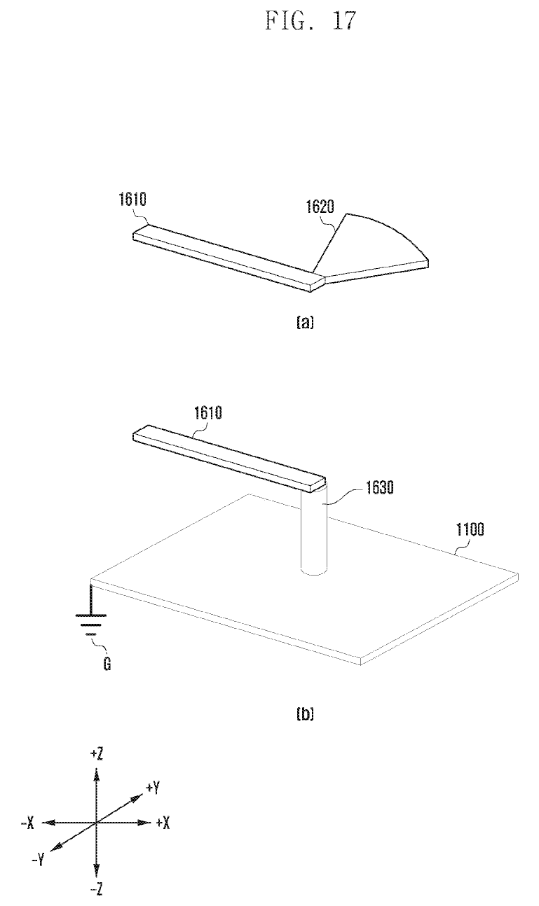

FIG. 17 illustrates RF chokes of a patch antenna according to an embodiment.

Referring to section (a) of FIG. 17, an RF choke of a patch antenna may include a feeding line 1610 and a radial stub 1620. The radial stub 1620 may have a fan shape that expands and extends in a third direction (+Y) from a point on one side surface of the feeding line 1610 with reference to an X–Y plane. One end of the feeding line 1610 may be electrically connected to one of a plurality of radiators.

Referring to section (b) of FIG. 17, an RF choke of a patch antenna may further include a feeding via 1630. One end of the feeding via 1630 may be electrically connected to a surface of the PCB 1100. The one end of the feeding via 1630 may be grounded (G) through the PCB 1100. The other end of the feeding via 1630 may be electrically connected to a point on a second surface of the feeding line 1610. The sum of the length of the feeding via 1630 and the length of the feeding line 1610 may be λ/4 with respect to a center frequency.

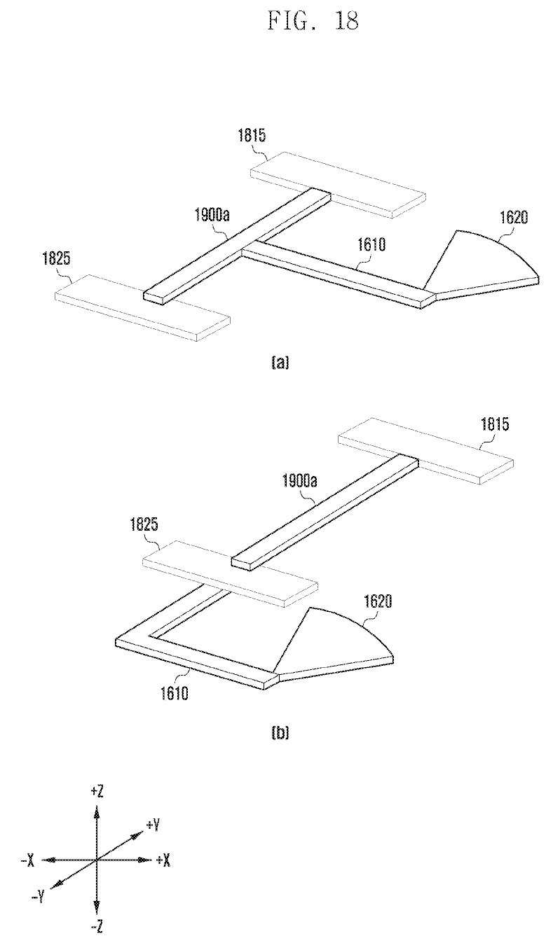

FIG. 18 illustrates transmission lines 1900a and an RF choke 1600 of a patch antenna 1000 according to an embodiment.

Referring to sections (a) and (b) of FIG. 18, the transmission line 1900a may be electrically connected to a second pad 1815 of a first radiator 1810 and a second pad 1825 of a second radiator 1820. One end of the transmission line 1900a may be electrically connected to one side surface of the second pad 1815 of the first radiator 1810. The other end of the transmission line 1900a may be electrically connected to one side surface of the second pad 1825 of the second radiator 1820. Transmission line 1900a may have a bar shape extending from one side surface of the second pad 1815 of the first radiator 1810 to one side surface of the second pad 1825 of the second radiator 1820.

Referring to section (a) of FIG. 18, an RF choke 1600 may include a feeding line 1610 and a radial stub 1620. The radial stub 1620 may have a fan shape that expands and extends in a first direction (+X) from a point on one side surface of the feeding line 1610 with reference to an X–Y plane. One end of the feeding line 1610 may be electrically connected to a central portion of one side surface of the transmission line 1900.

Referring to section (b) of FIG. 18, the RF choke 1600 may include a feeding line 1610 and a radial stub 1620. The radial stub 1620 may have a fan shape that expands and extends in a first direction (+X) from a point on one side surface of the feeding line 1610 with reference to a X–Y plane. The feeding line 1610 may have an L shape in which a central portion is bent substantially at a right angle. One end of the feeding line 1610 may be electrically connected to the other side surface of the second pad 1824 of the second radiator 1820.

Herein, each block of flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks(or functions) shown in succession may in fact be performed substantially concurrently or the blocks may sometimes be performed in the reverse order, depending upon the functionality involved.

As used in embodiments of the disclosure, a unit/module may refer to a software element or a hardware element, such as a field programmable gate array (FPGA) or an application specific IC (ASIC), which performs a predetermined function. However, the term including unit/module does not always have a meaning limited to software or hardware. The unit/module may be constructed either to be stored in an addressable storage medium or to execute one or more processors. Therefore, the unit/module includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the unit/module may be either combined into a smaller number of components and a unit/module, or divided into additional components and a ~unit/module. Moreover, the components and units/modules may be implemented to reproduce one or more central processing units (CPUs) within a device or a security multimedia card. The unit/module may include one or more processors.

The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP) or central processing unit (CPU), a communication processor (CP, e.g., a modem), a graphics processing unit (GPU), a neural processing unit (NPU) (e.g., an AI chip), a Wi-Fi chip, a Bluetooth® chip, a global positioning system (GPS) chip, a near field communication (NFC) chip, connectivity chips, a sensor controller, a touch controller, a finger-print sensor controller, a display driver IC, an audio CODEC chip, a universal serial bus (USB) controller, a camera controller, an image processing IC, microprocessors, microcontrollers, digital signal processors, FPGA, ASIC, a microprocessor unit (MPU), a system on chip (SoC), an IC, or the like. The one processor or the combination of processors executes instructions that can be stored in a memory, such as the operating system, to control the overall operation of the device. The one processor or the combination of processors is also capable of executing other processes and programs resident in the memory, such as processes for the disclosure.

It is be appreciated that various embodiments of the disclosure can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure. Additionally, or alternatively, such software may be a computer program [product] comprising instructions which, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or ICs or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

What is claimed is:

1. A patch antenna comprising:
a first radiator;
a second radiator disposed to face the first radiator at a predetermined distance in an −X-axis direction with respect to a Y-axis;
a first transmission line electrically connecting the first radiator and the second radiator; and
a first radio-frequency (RF) choke electrically connected to the first radiator,
wherein the first radiator comprises:
a first pad,
a second pad disposed to be spaced apart from a first surface of the first pad by a predetermined distance in a +Z-axis direction, and
a third pad disposed to be spaced apart from a first surface of the second pad by a predetermined distance in the +Z-axis direction,
wherein the second radiator comprises:
a fourth pad,
a fifth pad disposed to be spaced apart from a first surface of the fourth pad by a predetermined distance in a +Z-axis direction, and
a sixth pad disposed to be spaced apart from a first surface of the fifth pad by a predetermined distance in the +Z-axis direction,
wherein the first transmission line has a shape extending from one side surface of the second pad to one side surface of the fifth pad and electrically connecting the second pad and the fifth pad, and
wherein an impedance value of the first transmission line is substantially infinite.

2. The patch antenna of claim 1, further comprising:
a first via extending from the first surface of the first pad to a second surface of the second pad and electrically connecting the first pad and the second pad,
wherein the second surface of the first pad is grounded.

3. The patch antenna of claim 1, further comprising:
a second via extending from a first surface of the second pad to a second surface of the third pad and electrically connecting the second pad and the third pad.

4. The patch antenna of claim 1, further comprising:
a third via extending from the first surface of the fourth pad to a second surface of the fifth pad and electrically connecting the fourth pad and the fifth pad,
wherein a second surface of the fourth pad is grounded.

5. The patch antenna of claim 1, further comprising:
a fourth via extending from the first surface of the fifth pad to a second surface of the sixth pad and electrically connecting the fifth pad and the sixth pad.

6. The patch antenna of claim 1, further comprising:
a ground patch disposed to be spaced apart from a first surface of the first transmission line by a predetermined distance in a +Z-axis direction and disposed between the first radiator and the second radiator.

7. The patch antenna of claim 6, further comprising:
a first diode electrically connected to the third pad and the ground patch,
wherein a first electrode of the first diode is electrically connected to a first point of the ground patch and is a cathode, and
wherein a second electrode of the first diode is electrically connected to the third pad and is an anode.

8. The patch antenna of claim 6, further comprising:
a second diode electrically connected to the third pad and the ground patch,
wherein a first electrode of the second diode is electrically connected to a second point of the ground patch and is a cathode, and
wherein a second electrode of the second diode is electrically connected to the sixth pad and is an anode.

9. The patch antenna of claim 6, further comprising:
a third radiator; and
a fourth radiator disposed to face the third radiator at a predetermined distance in a −Y-axis direction with respect to the first transmission line.

10. The patch antenna of claim 9, wherein the third radiator comprises:
a seventh pad;
an eighth pad disposed to be spaced apart from a first surface of the first pad by a predetermined distance in a +Z-axis direction; and
a ninth pad disposed to be spaced apart from a first surface of the second pad by a predetermined distance in the +Z-axis direction.

11. The patch antenna of claim 10, further comprising:
a third diode electrically connected to the ninth pad and the ground patch,
wherein a first electrode of the third diode is electrically connected to a third point of the ground patch and is a cathode, and
wherein a second electrode of the third diode is electrically connected to the ninth pad and is an anode.

12. The patch antenna of claim 9, wherein the fourth radiator comprises:
a tenth pad;
an eleventh pad disposed to be spaced apart from a first surface of the first pad by a predetermined distance in a +Z-axis direction; and
a twelfth pad disposed to be spaced apart from a first surface of the second pad by a predetermined distance in the +Z-axis direction.

13. The patch antenna of claim 12, further comprising:
a fourth diode electrically connected to the twelfth pad and the ground patch,
wherein a first electrode of the fourth diode is electrically connected to a fourth point of the ground patch is a cathode, and
wherein a second electrode of the fourth diode is electrically connected to the twelfth pad and is an anode.

14. The patch antenna of claim 6, further comprising:
a second RF choke electrically connected to the second radiator, the third radiator, or the fourth radiator.

15. The patch antenna of claim 6, further comprising:
a fifth via extending from a first surface of the seventh pad to a second surface of the eighth pad and electrically connecting the seventh pad and the eighth pad,
wherein a second surface of the seventh pad is grounded.

16. The patch antenna of claim 9, further comprising:
a sixth via extending from a first surface of the eighth pad to a second surface of the ninth pad and electrically connecting the eighth pad and the ninth pad.

17. The patch antenna of claim 11, further comprising:
a seventh via extending from a first surface of the tenth pad to a second surface of the eleventh pad and electrically connecting the tenth pad and the eleventh pad,
wherein a second surface of the tenth pad is grounded.

18. The patch antenna of claim 11, further comprising:
an eighth via extending from a first surface of the eleventh pad to a second surface of the twelfth pad and electrically connecting the eleventh pad and the twelfth pad.

19. The patch antenna of claim 12, further comprising:
a second transmission line electrically connecting the third radiator and the fourth radiator,
wherein an impedance value of the second transmission line is substantially infinite (∞).

20. The patch antenna of claim 6, wherein the ground patch comprises a first ground patch and a second ground patch, and
wherein the first ground patch and the second ground patch are physically separated from each other.
